(19) United States
(12) Patent Application Publication
(10) Pub. No.: US 2007/0192279 A1
(43) Pub. Date: Aug. 16, 2007

(54) Advertising in a Database of Documents

(75) Inventor: Andrew S. Van Luchene, Santa Fe, NM (US)

Correspondence Address: GONZALES PATENT SERVICES, 4605 CONGRESS AVE. NW, ALBUQUERQUE, NM, 87114, US

(73) Assignee: LEVIATHAN ENTERTAINMENT, LLC, Santa Fe, NM (US)

(21) Appl. No.: 11/737,613

(22) Filed: Apr. 19, 2007

Related U.S. Application Data
(63) Continuation-in-part of application No. 11/668,596, filed on Jan. 30, 2007.
(63) Continuation-in-part of application No. 11/462,621, filed on Aug. 4, 2006.
(60) Provisional application No. 60/727,191, filed on Oct. 14, 2005.

(51) Int. Cl. G06F 17/30

(52) U.S. Cl. 707/1

(57) ABSTRACT

A database, such as a patent database, including a plurality of electronic documents, such as patents and patent applications, is described. The documents include words, phrases, and/or pictures that have been hyperlinked to advertisements or other documents. Also described are methods of indexing words and phrases in the documents and allowing advertisers, merchants, or other entities to pay for the right to hyperlink selected words, phrases, pictures that appear in the documents in the database to web-based documents of their choosing.

### CROSS REFERENCE TO RELATED APPLICATIONS

The present application is a continuation in part of U.S. patent application Ser. No. 11/668,596, “Keyword Advertising in Invention Disclosure Documents” filed Jan. 30, 2007, and Ser. No. 11/462,621, “Fee-Based Priority Queuing for Insurance Claim Processing” filed Aug. 4, 2006, which claims the benefit of U.S. Provisional Patent Application No. 60/727,191, filed Oct. 14, 2005, each of which is hereby incorporated by reference.

### BACKGROUND OF THE INVENTION

The internet allows people to access enormous amounts of information in a fast and efficient manner. Frequently, large numbers of related or unrelated documents are maintained in searchable databases, which users can access in order to find information of interest. An example of such a database includes the USPTO Patent and published patent application databases. Databases may be publicly or privately available and may or may not charge a fee for access. As the availability of information over the internet grows, advertisers continue to search for new ways to provide advertising to those consumers who seem more likely to be interested in their products and services. This decreases advertising costs, allowing merchants to increase revenue and pass savings on to consumers and/or increase profitability or both. Accordingly methods and systems to take advantage of the self-selectivity of database users by providing directed advertising to potential consumers based on the items viewed in a database would be advantageous.

### BACKGROUND OF THE INVENTION

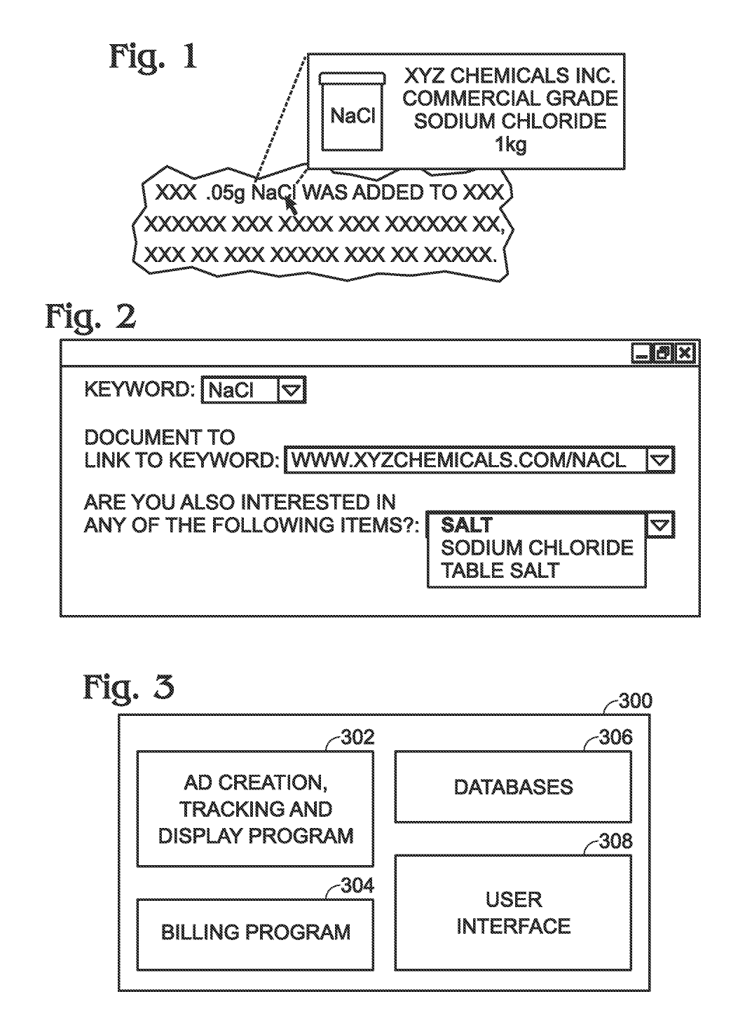

FIG. 1 depicts a keyword advertisement in a text.

FIG. 2 depicts a user-interface whereby a merchant or other user can hyperlink a destination document to a keyword.

FIG. 3 is a system diagram of a system suitable for use with the present disclosure.

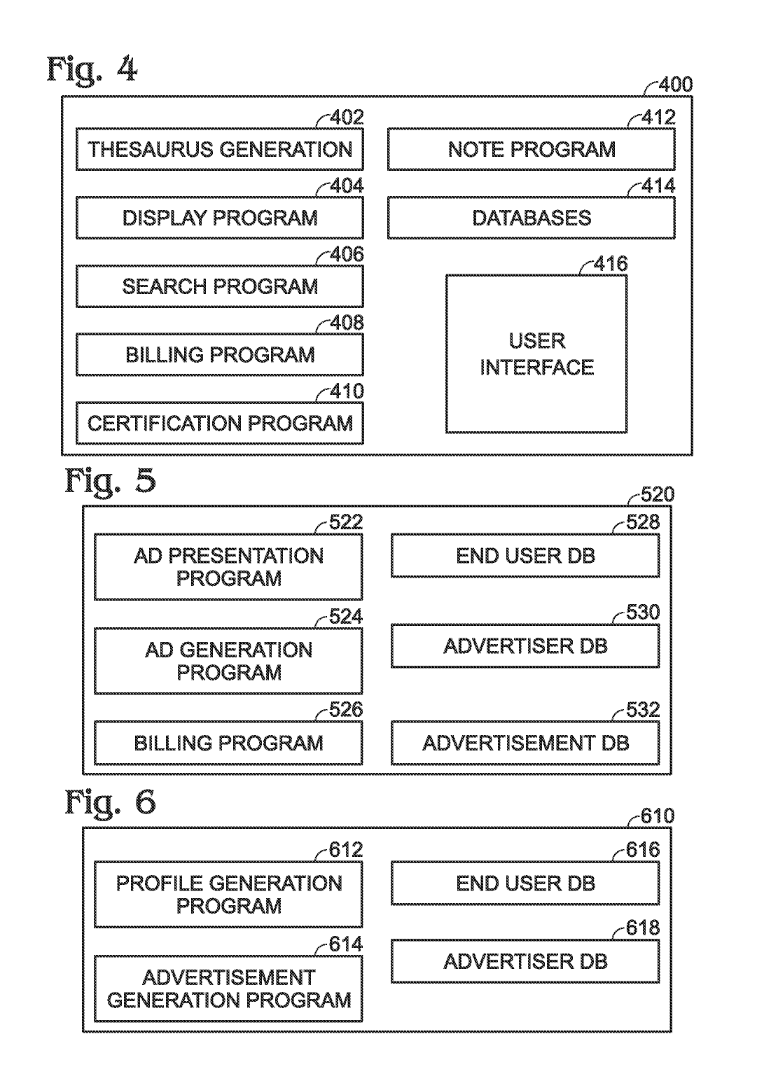

FIG. 4 is a system diagram of a system suitable for use with the present disclosure.

FIG. 5 is a system diagram of a system suitable for use with the present disclosure.

FIG. 6 is a system diagram of a system suitable for use with the present disclosure.

### DETAILED DESCRIPTION

The present disclosure provides mechanisms for directed advertising using document databases. A wide variety of document databases are available to computer users via private and public networks. Examples of document databases include the USPTO database of issued US patent applications, the USPTO database of published US patent applications, WIPO's international patent database, PUBMEDs database of biologically-related research articles, Wikipedia various journal collections and the like. Other examples of Document Databases that can offer this functionality include, but are not limited to:
1. Other government databases, e.g., Library of Congress
2. Product Reviews, e.g., consumer reports
3. User and Technical Manuals
4. Magazine and Newspaper Articles
5. Advertisements
6. Online Books or Encyclopedias
7. Libraries
8. Search Engines
9. Business Databases
10. Public and Private Institutions

According to some embodiments, the databases described herein may be static databases, by which it is meant that the content of the database is not altered. According to other embodiments, the databases described herein may be periodically updated. Databases that are updated periodically may be updated at regular periodic intervals. For example, the USPTO published patent application and issued patent databases are updated once a week. Other databases may be updated monthly, biannually, annually, etc. Alternatively, some databases may be updated at irregular periodic intervals, for example, some databases may be updated each time a given number (e.g. 5, 10, 50, 100) of new documents are ready for addition to the database. According to still further embodiments, the databases described herein may be updated dynamically, that is, new content may be added and old content may be removed at any time, for example, as soon as the new content is received.

Generally, electronic document databases provide some type of search tool that allows users to identify and then browse through documents of interest. For the purposes of the present disclosure, a document includes any article, patent, journal entry, blog, webpage, or the like that furnishes information, documents, images, audio or any other data to a user.

For the purposes of the present disclosure, the term advertisement may take the form of any communication or message via any medium to any one or more end users or any person or third party and/or any system owned, accessed, operated or controlled by any such end user, person or third party. Suitable communications may include any one or a combination of text, audio, video, icons, graphics, images, hyperlinks, alerts, etc. Advertisements may include an offer for sale, for profit or not, and may or may not include a discount, for any services, products, financial instruments, e.g., insurance, annuities, securities, e.g., stocks, bonds, options, etc. and/or any other good or service, and/or may provide information or an offer to obtain or otherwise access or receive information about any of the foregoing or anything, such as a request for donations to political or charitable or any other entity or organization. An advertisement might be used or designed to provide information to inform or educate or identify any constituent and/or may include communications in support of any one or more objectives such as public relations, publicity, product placement or introduction, sponsorship, underwriting, public notice or service announcement, calls for action, or any other objective or purpose.

According to one embodiment, the present disclosure provides a mechanism whereby merchants or other entities can purchase, lease, rent or otherwise acquire the short, long term or permanent right to hyperlink to any one or more predetermined words, phrases, diagrams, drawings, images, audio, video, objects, or entire documents, etc. (collectively “keywords”) that appear in a database of documents. A hyperlink is generally a computer actionable set of instructions or code, which may be embedded or otherwise associated with or connected to an element, word, object, icon, document, figure, map, file attachment, or other displayed area within, a document or webpage. When selected, clicked or otherwise activated a hyperlink may cause a computer to perform one or more functions, e.g., retrieve and/or display new or additional information and/or redirect an end user to a different area of the same or a new web page and/or website, and/or may cause other actions to be taken, e.g., display a advertisement, solicit and/or capture information about the word, end user, or system that stores, retrieves or displays the words and/or documents and/or the system that is accessing the word or document, and/or open a form that requires end user review, acknowledgement or input, and/or may display new information that is generally associated with and/or relates to such link. Such new or additional information and/or webpage(s) may or may not be displayed using a separate or new web browser page, web browser tab, or popup window or interstitial. Hyperlinks are commonly identified through the use of an underline and/or color coding, e.g., HYPERLINK, but this is not necessarily required or desired. Hyperlinks may be activated by any applicable means, including, but not limited to, left or right clicking on or near the link and/or performing one or more additional actions, e.g., a selection from a list after such left or right clicking, placing a pointer on or near the link (briefly, temporarily or not), touching the area, e.g., via use of a touch screen or other pointing mechanism, and/or automatically, e.g., based upon date or time, or other action or inaction of the end user, e.g., failure to respond within a given timeframe may cause execution or delay of execution of one or more computing steps or hyperlink(s). Such links may be associated with one or more other hyperlinks, e.g., hyperlinks within hyperlinks, documents, programs, words, phrases, or other information or actions. Furthermore, hyperlinks may include branching or other computing logic to determine which next steps should be or must be performed and/or in what sequence. For example, if an end user right clicks on a hyperlink, one or more options may appear, permitting the end user some degree of flexibility in the action or actions taken and/or such subsequent actions may occur in whole or in part automatically. The terms link and hyperlink shall have corollary meanings.

Methods to create web pages, hyperlinks and hypertext and/or advertisements and/or notes are well known in the prior art and any person with ordinary skill in the art can design and create such hyperlinks. Methods to design and create hypertext and/or hyperlinks are discussed and disclosed by the authors of the following reference and other materials, including, for example: “Intelligent Hypertext: Advanced Techniques for the World Wide Web (Lecture Notes in Computer Science), by Charles Nicholas and James Mayfield,” “Information Architecture for the World Wide Web: Designing Large-Scale Web Sites [ILLUSTRATED], by Louis Rosenfeld (Author), Peter Morville,”Creating Web Pages with HTML Simplified, by Sherry Willard Kinkoph (Author),” “Master Visually Web Design (With CD-ROM) by Carrie F. Gatlin and Michael S. Toot,” and “Creating Internet Intelligence: Wild Computing, Distributed Digital Consciousness, and the Emerging Global Brain (IFSR International Series on Systems Science and Engineering), by Ben Goertzel.” Each of which are hereby incorporated by reference.

The hyperlinked words, phrases, documents, or objects may then direct a user who selects or otherwise activates the hyperlink to a target site, document, location, additional information, advertisement, etc. of the merchant's choosing. For example, as shown in FIG. 1, a chemical manufacturer may choose to hyperlink each instance of the term “NaCl” that appears in a database of scientific journal articles to a catalog webpage featuring the chemical manufacturer's commercially available sodium chloride. For the purposes of discussion, the term “merchant” may be used to indicate the entity that provides the advertising (or other target document or resource) that is to be hyperlinked to the keyword. However, it should be understood that the term is not intended to be limiting and that any entity, whether or not they have goods or services available for sale, may be able to take advantage of the system described herein. For example, an activist group that opposes the use of salt in certain processes may choose to display an advertisement or additional information designed to educate the end user about their views and/or objections. The group may not be selling salt or any other product. Furthermore, such a group may or may not desire to solicit additional members or funding of their group.

According to one embodiment, the words, phrases, drawings, figures, tables, etc. that appear in a particular database may be sorted, counted and indexed to allow for easier recall and to provide merchants or end users with general information about words or phrases that they are, or might be, interested in hyperlinking to a target document. For example, a particular merchant might be interested to know that the term “sodium chloride” appears 100 times in the database, but only in two documents, while the term “NaCl” appears 200 times and in 50 different documents.

Alternatively or additionally, a database of documents may be analyzed and, the various words, phrases, and documents are divided into meaningful categories or groupings. For example, the words, phrases, figures, and documents in a database of US patents may be divided and/or categorized according to standard USPTO class and subclass definitions. In this instance, a merchant may wish to link his advertising for commercial grade sodium chloride to the term “salt” only when it appears in a patent application that has been classified as being for certain biological processes.

Methods to search, web crawl, index or otherwise examine the Internet and World Wide Web are well known within the prior art. For example, such methods are disclosed and discussed in the following reference materials and books, including: “Mining the World Wide Web—An Information Search Approach (The Kluwer International Series on Information Retrieval, Volumes 1-10) (The Information Retrieval Series) by George Chang, Marcus Healey, and James A. M. McHugh and “Google's PageRank and Beyond: The Science of Search Engine Rankings,” by Amy N. Langville, Carl D. Meyer, and “Internet Searching and Indexing: The Subject Approach, by Alan R. Thomas and James R. Shearer (Editor),” which are incorporated herein by reference.

As shown in FIG. 2, a user interface such as a web based tool or other application is then provided wherein a merchant or other entity can log in to the tool and indicate the type of documents, words or other elements, e.g., figures and figure components, in which the merchant is generally interested. The merchant may indicate an interest in any one or more documents or words, phrases, images, objects, video, audio or any other data (collectively “words”) and choose to add one or more hyperlinks to be associated with such words. Such web based tool may permit the merchant to generate or assign hyperlinks to a single database, e.g., the USPTO database, or multiple databases.

In the event that a merchant is interested in more than one word (or phrase), the tool may be configured such that the merchant(s) can provide the system with a prioritized list of the words (or phrases) of interest.

In certain embodiments, merchants may desire to display advertisements for words and/or one or more of any or all such words' synonyms and/or antonyms and/or any related figures. Exemplary methods to determine relevant synonyms and/or antonyms to use for such associations are described in greater detail below.

According to an embodiment, merchants can offer to pay to have one or more hyperlinks, advertisements and/or notes associated with one or more words and/or any one or more words' synonyms and/or antonyms. For example, a merchant that sells batteries may be interested in the words: battery, batteries, electricity, electrical, electrical storage devices, chemical energy, electrical energy, power cell, standby power, among others. The merchant may choose to pay a fee to generally associate a hyperlink with any one or more of such words. Fees may vary based upon any terms and conditions. For example, the number or type and/or frequency of appearance of a given word in one or more documents, demand for hyperlinks to a word by one or more other merchants or other third parties, or may be fixed or vary based on any suitable means including based upon market forces, auctions, or any other means of establishing a price or pricing models and/or terms and conditions. The merchant may be willing to pay a higher fee for a certain word or words, e.g., battery, or group of words, e.g., battery, batteries and Duracell, while he may be less willing to pay or only willing to pay a lesser amount for other certain words, e.g., chemical energy device. In such cases, the merchant may opt to pay a higher fee for certain words and a lower fee for other words. Furthermore, a merchant may wish to engage in differing fee structures for keywords that appears in different categories, classes, or groupings of documents and/or based upon frequency of display and/or access of any such words. In certain cases, merchants may be willing to pay up to a certain limit or fee and will then only be charged when the prevailing rate is at or below such limit and no other merchant is willing to pay an amount higher than such limit.

In certain embodiments, a merchant may pay the same amount for creating a link to any or all words, and/or one or more synonyms and/or antonyms or other documents. In other embodiments, the fee may be determined by any applicable means, such as one or more of the following, including, but not limited to: the number or type of documents, words, synonyms, antonyms, figures, attachments, and/or the type of hyperlink, e.g., an ad versus a short description hyperlink vs. an ad plus right click options, whether or not the end user clicks, right clicks, reads the popup ad or takes other actions, e.g., fills out a form, buys a product, takes a test drive, performs a task, provides information about himself or others, etc. Fees may be fixed or variable or both. Fees may be additive or limited. Merchants may establish a budget or other payment rules, including, for example, limits on fees per click through, hour, day, week, month, year, and/or by class of end users or any other applicable restrictions or permissions desired by any such merchant.

In another embodiment, the merchant may wish to indicate the type of documents that he's interested in. For example, a merchant that sells batteries may wish only to include hyperlinks in patent documents (e.g., issued and pending) that belong to a certain field of use or class, e.g., electrical devices or consumer products, etc. By restricting hyperlinks to certain classes of documents, the merchant may avoid paying for hyperlinks associated with words within documents of little interest, e.g., spacecraft, in which case, the merchant may not have products that satisfy such a specialized field. Accordingly, a merchant may be willing to pay more to link his advertising to keywords that appear in documents that are categorized or classified in a group that closely relates to the intended use of the advertised good or service and/or less for those that are or may be of lesser interest or benefit or applicability to such merchant.

In another embodiment, the merchant may select a group of documents and view the counts of words by individual document, document class, and document subclass. The merchant can select a word in one or more documents, document classes and document subclasses and pay to have that word hyperlinked to an advertisement, such as a popup ad, interstitial ad, or a webpage (which may open another window, or redirect the user or provide an option to the user) and/or take other action(s), such as requesting the end-user to fill out a survey.

In the event that multiple merchants are willing to pay for a hyperlink to one or more words, the system may provide a generic hyperlink whose actions are determined prior to or generally at the time of use. For example, if two battery manufacturers desire hyperlinks to be associated with the word battery, when an end user, for example, clicks on the word battery or otherwise activates the hyperlink associated with the word battery or any other associated hyperlink, e.g., a synonym, any one or more of the following may occur including: 1) the system may ask the end user to provide additional information about the request for information, e.g., the system may ask the end user to fill out a survey or answer one or more questions, e.g., Are you interested in commercial or household use batteries?, 2) the system may determine which merchant's ad, the order of the ads, or other action to take based upon any one or more of the following, including: a) the price paid or that would be paid by one or both (or more) merchants, b) information about the document or the end user, c) a comparison of information about the end user and/or merchant and/or document and/or word(s), d) a selection provided by the end user, e.g., making a choice after right clicking a word and then selecting from a menu of choices, e.g., receive more information, display website, order now, etc. e) prior actions or behaviors or areas of interest of the end user, and/or f) any other available information about any business objectives or one or more merchants and/or end user objectives or preferences or buying habits and/or other information including, for example, demographic or financial information, e.g., credit or payment history, etc.

It will be appreciated that according to some embodiments, the merchant can select more than one word and hyperlink that word to the same advertisement or web page. For instance, the merchant can select both “CPU” and “Processor” to be linked to the same advertisement.

Once the merchant has selected one or more words and created or otherwise indicated or provided the hyperlink to an advertisement, webpage, additional information, survey, or other action step, end users who search the database of documents can see the hyperlinks of the words in the database to the merchant's advertisements, web pages, additional information, or survey or other actions. End users may then choose to activate any one or more of the hyperlinks, as they wish. In addition or in the alternate, such hyperlinks may be automatically activated without end user intervention, permission or action. For example, when an end user views a given document, word, phrase, figure or image, the disclosed system may automatically activate one or more hyperlinks associated with such document, word, phrase, figure or image. This method may prove useful, for example, in systems where end users are provided access for free or for a reduced fee if they agree (e.g., opt in) to view one or more advertisements in exchange for such usage. Such display or one or more advertisements may be immediate or delayed.

In certain embodiments, a server application is provided to permit: 1) the analyzing of documents across many servers, web pages, databases, etc., 2) merchants or other interested third parties to indicate which a) words, synonyms, antonyms, figures, images, documents, types or classes or subclasses of documents, etc., that the merchant would be interested in generally or providing a hyperlink, and/or 3) end users can visit as a starting or mid-point to enter or search for words and receive a list of one or more hyperlinks based upon such entry or search and, which search may be determined by any applicable means, including, any one or more of: i) use of any existing or known search algorithm, ii) based upon merchant payments and/or end user profile preferences, iii) responses to one or more survey questions by merchants and/or end users. Methods to provide for such survey questions and gathering of data are disclosed by applicants in U.S. Patent Application No. 60/774,177, entitled “Survey Based Qualification of Keyword Searches,” Ser. No. 11/278,123, also entitled “Survey Based Qualification of Keyword Searches” Ser. No. 11/562,738 “Survey Based Qualification of Keyword Searches” and Ser. No. 11/608,150, entitled “Map and Inventory Based On-Line Purchases” which applications are incorporated herein by this reference, iv) past searches conducted by the end user, v) actions taken in response by such end users, e.g., the purchase of a product or use of certain information, or feedback by the end user, e.g., a follow-up survey and/or any combination of the foregoing.

According to yet another embodiment, merchants may opt to hyperlink all or only some occurrences of words, synonyms, antonyms, documents, figures and/or images. In certain embodiments, for example, one or more merchants may opt to hyperlink or otherwise be associated with specific words or phrases and/or based upon the context of use of such words or phrases. Merchants and/or the system may determine which words to associate with which merchants. Such determination may be made by any applicable means, including, any one or more of the following, such as: the total count of a word or words in a document, the relevancy of the document and/or the context or use of the word or words to the merchant's line of business or other interest, the relevancy of the database or class, sub-class or other category of the database and/or document and/or paragraph and/or word or words and/or the context of the sentence or paragraph in which the word or words were used, or any other variable or condition, for example, a merchant may indicate interest based upon the level of interest shown or willingness to pay for any given word or words of one or more of the merchant's competitors, and/or the success of the merchant and/or any one or more of merchant's competitors based upon hyperlinks associated with the same or similar words, e.g., synonyms, within the same or similar documents and/or within the same or similar database, category or class or sub-class of documents and/or databases. In yet other embodiments, such relevancy may be determined, in whole or in part, through the use of automated means. In addition to the novel relevancy methods disclosed herein, other methods to determine relevancy between and among documents and/or websites are well known within the prior art, including, for example, the methods discussed in the book entitled “Text Databases and Document Management: Theory and Practice, by Amita Goyal Chin, which is incorporated by reference.

In another embodiment, merchants may rank the priority of certain words, or the position or context of words within a given document. For example, if the word appears early in a document, e.g., a patent title, or in an index of a user manual, a merchant may be willing to pay a higher or lower or no amount for such word positioning.

In certain embodiments, merchants may limit their advertising exposure. Such limitations may or may not take into account the “conversion rate” of those clicking on one or more links. For example, a merchant might indicate that the total budget for advertisements associated with documents in the USPTO patent database should be limited to $5,000 per month. Such Merchant may add a stipulation or exception to such rule, e.g., “unless revenues greater than $50,000 are generated as a result of end users clicking on such words/hyperlinks.” In this way, the total amount a given merchant is willing to spend may be based in whole or in part upon the general effectiveness of such advertising/hyperlinks. Limitations may be established or determined by any applicable means, including, for example, total costs per use, click, click through, conversion, day, week, month, year, maximum amount for the life of the document or word, limits based upon competitive influences, success rates, frequency and type of changes to the word, words, paragraphs, documents, databases or any other variables, and any combination of the foregoing, including any changes in trends or rates of change, or newly emerging trends, e.g., a sudden or other increase in click through using similar words or the same words elsewhere within the document and/or the database and/or generally. The system may monitor any available or applicable data, including usage rates, click through rates, sales, failure to close sales, sales or success of the merchant and/or any one or more of merchant's competitors, and/or results known or gathered regarding the same or similar results within one or more search engines or other advertising systems, any or all of which may be used in any combination to determine the amount a merchant is willing to pay or budget for payment for advertising, which limits may be fixed or variable or a combination of fixed and variable amounts.

In addition to purchasing the word as a hyperlink, the merchant can also purchase a brief text description of the word, i.e. for the word CPU, the advertiser could select, “such as the Centrino manufactured by Intel” as a text description that is added to the word everywhere it is listed in a document. End users who search the database could elect, on a temporary, permanent or ad hoc basis, and/or at will or as desired, to hide or show these brief text descriptions along with the original text of the document(s). Or, users could elect to have such descriptions (short or long) appear as comments when the user positions their cursor over or near the hyperlinked word or phrase or right clicks on the hyperlinked word or phrase.

In yet another embodiment, merchants can bid to have their advertisement presented if a hyperlinked keyword is clicked by an end user. If multiple merchants are bidding on the word, the hyperlink, when clicked, can show a list of advertisers in the order of highest to lowest bidder, and/or the highest bidder's link appears more often than other bidders and/or uses a different text font or color and/or an icon, such as a logo, could appear for the highest bidder. In another embodiment, those that are competing for the same noun (for example), might have their hyperlinks associated with the noun for some frequency other than 100% of the time. The link appearance or frequency might be based upon the price paid, the relative price paid, i.e., as compared with all others vying for the same noun, randomly, in order, i.e., highest paid fee appears first, second highest fee paid appears secondly, and so on. Such preferential display may affect all of the same nouns in a given document, or it may vary. For example, if Vendor A pays $0.05 per click through, and Vendor B pays $0.025. The system might display a hyperlink on all paid nouns, e.g., car, for 75% of the time (on all words that include “car”) for Vendor A, while vendor B's link only appears 25% of the time (on the same words). In addition or in the alternate, Vendor A's link may appear on only 75% of the words, but is displayed all the time, while Vendor B's hyperlinks may only appear on 25% of the words with the letters “car”. In this fashion, the probability that an end user will click on Vendor A's hyperlink is expected to be roughly or generally 75%. In yet another embodiment, when there are two or more merchants that desire a link to appear for a given word, the system may only display the top “n” number of such links, where “n” is some number other than the total number of merchants that desire such hyperlinks to be displayed. The value of “n” may be determined using any applicable means, including, for example, limiting to a specific number, e.g., three such merchant's, or may determine such limit based upon the number of merchants and the amounts each are willing to pay for such display and then limiting such number to a certain percentile, e.g., the top 30% of potential revenues generated if an end user were to click on such hyperlink(s). In certain embodiments, the system may determine the likelihood that a given end user may click on one or more such hyperlinks and display such hyperlinks in an order to encourage such action, e.g., even though a given merchant is willing to pay

In another embodiment, other factors can control the number and frequency of activated hyperlinks, including, but not limited to: Total vendors/third parties that have purchased or are vying for the right or otherwise desire to include one or more hyperlinks, total number of words linked, success or click through rates, success of sales, quantity or quality of information gathered via one or more surveys or any other applicable means or any combination of the above.

According to various embodiments, other possible hyperlink actions include: Option to indicate that the end user wishes to receive additional information, immediate or delayed: look up of a definition, synonym or antonym, popup of an ad, redirection to another website, which may or may not be provided via a separate browser page, skip to the next use of the word or part of the word or to another related or unrelated section within the current or other document or website, popup of a synonym or antonym (with an option to jump to any such synonym or antonym (if present) within the text or the merchant's website, replace the word with or add a description to the word, e.g., short or long description, or synonym or antonym or any other applicable options, and/or any one or more or combination of the foregoing. In certain embodiments of the present invention, any one or more of the foregoing actions may be accomplished by submitting such word or words or phrases to an existing search engine, including, fore example, Yahoo or Google.

In certain embodiments, the selection of an appropriate hyperlink and/or fees may be determined based in whole or in part upon the actual usage or success or click through rates, end user satisfaction surveys, and/or amount of revenue generated by word, merchant, end user, server, database, document, document type or class, etc. Such a system could measure actual usage for each of the preceding characteristics and adjust or change which hyperlinks are displayed or are otherwise in effect and/or modify fees for display or use of such hyperlinks so as to drive optimum results. Optimum results may mean and/or include any one or more of the following: 1) amount of revenue generated for the service that provides such hyperlinks, 2) amount of revenue received by merchants, 3) frequency that end users click through on such hyperlinks 4) percentage of end users that purchase the advertised product, view a demonstration, read information, take an action, respond to a survey, request a brochure or additional information, 5) conversion rates, and/or 6) relevancy or usefulness of hyperlinks as determined by the end user, or the system or the merchant, 7) end user's preferences, or satisfaction with such hyperlink, merchant or advertisements, or a combination of any one or more of the foregoing. In such a system, hyperlinks could be randomly tested to determine initial acceptance/usefulness, and/or they could be tested based upon initial revenue projections or merchant's willingness to pay or via any other applicable means, including, for example, use of a genetic algorithm or neural net to test and automatically optimize use over time.

Use and applications of rules based, expert systems and/or genetic algorithms are well known in the prior art and may be implemented using any applicable means. For example, methods to develop rules, expert systems and/or genetic algorithms are discussed and disclosed in various issued and pending patents and reference and other materials, including the following books entitled: “Genetic Algorithms in Search, Optimization, and Machine Learning”, by David E. Goldberg, and “An Introduction to Genetic Algorithms,” by Melanie Mitchell, and “Expert Systems: Design and Development,” by John Durkin,” and “Logical Foundations for Rule-Based Systems (Studies in Computational Intelligence),” by Antoni Ligeza, each and all of which are incorporated herein by reference.

In certain embodiments, the disclosed invention may be applied to any database and/or multiple databases, for example, a database of books, such as that maintained by Amazon.com. In such cases, merchants or any person, company, business entity, charitable entity or other third parties may determine that hyperlinking one or more words, phrases, documents, or an entire databases may be desirable. In such cases, merchants or any person, company, business entity, charitable entity or other third parties, may provide an indication or rules or terms and conditions under which any one or more of the preceding entities may wish to purchase or agree to pay for or otherwise be associated with and/or control an association with or over any one or more such word, words, phrases, documents and/or hyperlinks (and or the order of any or all of the foregoing) and/or to establish a budget or rules regarding such budget for such use in determining which such entities would have use or control over, whether temporary or otherwise, any such hyperlinks.

In certain embodiments, before displaying an advertisement and/or before presenting a list of words and/or documents, e.g., from a lexicon of words, it may be desirable to ascertain certain additional information about such words, documents, advertisement and/or request for information. In such cases, the system may determine that it is necessary, desirable or generally useful to present one or more survey questions to aid in determining which words, documents, or other information should be presented, e.g., to help determine which advertisement might yield generally better results, and/or which word or synonym is generally more relevant given the information known about the end user and/or collected by using and/or displaying and/or gathering results from one or more such survey questions. For example, when an end user enters the word “case” into a search tool designed to retrieve a definition of such word or words, the system might ask the end user the following question or questions: e.g., are you an attorney, are you interested in travel, or are you seeking legal advice. Based upon the end user's response, e.g., if the end user responded in the affirmative to the last question, the system might either provide a definition of “case” to include legal cases, and/or the system may also provide an advertisement for one or more attorneys seeking clients. Based upon the response to one or more questions, the system may present additional qualifying questions, i.e., additional questions to further narrow the search results and or the sort display results.

In yet another embodiment, merchants or advertisers may wish to be notified upon the occurrence of certain events or conditions. Such events include: the acceptance or assignment or association of an advertisement with one or more documents or words, the use or activation of a hyperlink or an advertisement, and/or one or more sales, total target or some other metric or objective, the availability of a formerly unavailable word or document for advertisement inclusion, or any other change in data or applications of interest to such merchant or advertiser. Such notifications may be made via any applicable means, e.g., and email or other message. Such methods to determine alert events and/or to send alerts are disclosed for example, in U.S. patent application Ser. No. 11/676,848 which is incorporated herein by reference.

According to yet another embodiment, merchants or other potential keyword purchasers can be offered the choice to buy hyperlinks to words in a database of documents as one of the options when they buy keywords for search engine queries.

Those having skill in the art will recognize that there is little distinction between hardware and software implementations. The use of hardware or software is generally a choice of convenience or design based on the relative importance of speed, accuracy, flexibility and predictability. There are therefore various vehicles by which processes and/or systems described herein can be effected (e.g., hardware, software, and/or firmware) and that the preferred vehicle will vary with the context in which the technologies are deployed.

At least a portion of the devices and/or processes described herein can be integrated into a data processing system with a reasonable amount of experimentation. Those having skill in the art will recognize that a typical data processing system generally includes one or more of a system unit housing, a video display device, memory, processors, operating systems, drivers, graphical user interfaces, and application programs, interaction devices such as a touch pad or screen, and/or control systems including feedback loops and control motors. A typical data processing system may be implemented utilizing any suitable commercially available components to create the gaming environment described herein.

Accordingly, the presently described system may comprise a plurality of various hardware and/or software components such as those described below. It will be appreciated that for ease of description, the variously described hardware and software components are described and named according to various functions that it is contemplated may be performed by one or more software or hardware components within the system. However, it will be understood that the system may incorporate any number of programs configured to perform any number of functions including, but in no way limited to those described below. Furthermore, it should be understood that while, for ease of description, multiple programs and multiple databases are described, the various functions and/or databases may, in fact, be part of a single program or multiple programs running in one or more locations.

FIG. 3 provides an exemplary systems diagram of a system 300 that may be configured to perform the functions described here. As shown, system 300 may include an:

1. Advertisement Creation, Generation, Display and Tracking Program 302. This program may include all the software modules required to create and display the advertisements that are to be associated with the merchant—selected keywords. This program may also track advertisement and keyword-related activities, such as whether purchases or additional inquiries are made from a consumer, whether links in the advertisements are clicked by the consumer, etc.

2. Billing Program 304—this program may be configured to manage all of the billing associated with the purchase of keywords, display of advertisements, etc.

It will be appreciated that system 300 may further include a plurality of databases 306 configured to store, track, and interrelate a wide variety of data. Exemplary Databases and their associated data include:
1. Word Database
   a. Word ID
      1. Word Count ID
      2. Word
      3. Primary Definition
      4. Hyperlinks 1-N (e.g., sources/locations of use)
      5. Alternative Definitions 1-N
         a. Definition
         b. Supplied By—ID
         c. Hyperlinks 1-N
      6. Synonym ID-1-N
         a. Synonym
         b. Word ID
         c. Relevancy Scores 1-N
         d. Primary Score %
         e. Alternative Score %'s 1-N
      7. Antonym ID-1-N
         a. Antonym
         b. Word ID
         c. Relevancy Scores 1-N
         d. Primary Score %
         e. Alternative Score %'s 1-N
      8. Notes 1-N
         a. Note ID
         b. Note Short Description
         c. Note Long Description
         d. Narrative Text
         e. Attachment Hyperlinks 1-N
         f. Where Used Hyperlinks 1-N
      9. Figure IDs 1-N
      10. Change Tracking ID 1-N
      11. Notes 1-N
2. Change Tracking Database
   a. Change Tracking ID
   b. Word ID
   c. Change Type (e.g., Add, change, delete)
   d. Change Description
   e. Date/Time
   f. User ID
   g. Before Image
   h. After Image
   i. Relevancy or score
   j. Notes 1-N
1. Figure Database
   a. FIG. ID
   b. Figure Description
   c. Figure or Attachment
   d. Submitted By ID
   e. Source ID
   f. Editor Application ID
   g. Document/Patent Application Where Used ID 1-N
      1. Hyperlinks 1-N
   h. Notes 1-N
2. Document Database
   a. Document ID
      1. Document Description
      2. Document Owner ID
      3. Hyperlinks (e.g., document locations) 1-N
      4. Class 1-N
      5. Subclass 1-N
      6. Type 1-N
      7. Subtype 1-N
      8. Date/Time Stamps
         a. Submitted/Found/Indexed On
         b. Submitted/Found/Indexed By ID or Hyperlink
         c. Revised On 1-N
         d. Revised By 1-N
         e. Before Image 1-N
         f. After Image 1-N
      9. Notes 1-N
3. Advertiser or Notes Owner Database
   a. Advertiser/Owner ID
   b. Advertiser/Owner Name
   c. Classes of Trade 1-N
   d. Advertiser/Owner Financial Information
      1. Billing Method ID
      2. Credit Card Information
         a. Preferred Card Number
         b. Preferred Card Holder
         c. Preferred Card Type
         d. Name
         e. Expiration Date
         f. Security Code
      3. Additional Cards 1-N
         a. Card Number
         b. Card Holder (e.g., Bank Name)
         c. Card Type (e.g., Visa)
         d. Name
         e. Expiration Date
         f. Security Code
   e. Advertiser/Note Owner Mailing Address
   f. Advertiser/Note Owner Rules Database
      1. Rule ID 1-N
         a. Word(s)/Documents Applied To 1-N
         i. Rule Description
         ii. Rules 1-N
         iii. Billing Terms and Conditions ID 1-N
   g. Advertiser/Note Owner Attorney of Record
      1. Attorney ID 1-N
   h. Advertiser/Note Owner Qualifications 1-N
   i. Notes 1-N
4. Advertiser/Note Owner Qualifications Database
   a. Qualification ID
   b. Description
   c. Qualification Type
   d. Years Experience
   e. Fields of Use Applicable 1-N
   f. Notes 1-N
5. Attorney Database
   1. Attorney ID
   2. Name
   3. Address
   4. Description
   b. Notes 1-N
6. Billing Terms and Conditions Database
   a. Billing Method ID
   b. Billing Type
   c. Description
   d. Billing Frequency
   e. Due by # days
   f. Late by # days
   g. Interest Rate Fixed
   h. Interest Rate Variable
   i. Interest Accrues after days
   j. Notes 1-N
7. Accounts Receivable Database
   a. Advertiser/Note Owner ID Total Amount Owed
   b. Transaction Detail Records 1-N
      1. Date of Transaction
      2. Type
      3. Advertisement ID
      4. Word ID
      5. Hyperlinks 1-N
      6. Amount per impression or click through
   c. Notes 1-N
8. Search Database
   a. Document ID
   b. Document Location/Hyperlink
   c. Notes 1-N
9. Transaction Database
   a. Transaction ID
   b. Description
   c. Date/Time
   d. Type
   e. Advertiser/Note Owner ID
   f. Advertisement/Note Owner Rules Used 1-N
   g. Billing T&C's 1-N
   h. Billing Method ID
   i. Transaction Amount
   j. Results 1-N
      1. Note Added, Changed, Deleted, and/or Accessed
      2. Hyperlink Clicked
      3. Sub-Hyperlinks Clicked 1-N
         a. Advertisement/Note and/or Webpage) Displayed 1-N
         b. Click Through y/n
         c. Duration of view
         d. Conversion y/n
         e. Conversion dollar amount
      k. Notes 1-N
10. Advertisement Database
   a. Advertisement ID
   b. Advertiser ID
   c. Description
   d. Words 1-N
   e. Documents 1-N
   f. Hyperlinks 1-N
   g. Advertising Content File 1-N
   h. Notes ID 1-N
11. Document Class Database
   a. Class ID
   b. Description
   c. Notes 1-N
12. Document Sub Class Database
   a. Subclass ID
   b. Description
   c. Notes 1-N
13. Document Type Database
   a. Type ID
   b. Description
   c. Notes 1-N
14. Document Sub Type Database
   a. Subtype ID
   b. Description
   c. Notes 1-N
15. Group Database
   a. Group ID
   b. Description
   c. Notes 1-N
16. Advertisement Type Database
   a. Type ID
   b. Description
   c. Notes 1-N
17. Word Count Database
   a. Word ID
   b. Number of Occurrences
   c. Hyperlinks 1-N
   d. Notes 1-N
18. Survey Database
   a. Survey ID
   b. Survey Description
   c. Advertiser ID
   d. Survey Question ID 1-N
      1. Question
      2. Answer Options 1-N
   e. Notes 1-N
19. Results Database
   a. Result ID
   b. End User ID
   c. Survey Questions 1-N
   d. Survey Answers 1-N
   e. Date/Time Stamp
   f. Narrative or Text Responses 1-N
   g. Notes 1-N
20. Rules Database
   a. Rule ID
   b. Rule Description
   c. Rules 1-N
21. Search and Survey Database
22. Word Descriptor Database
23. Notes Database
   a. Note ID
      1. Hyperlinks 1-N
      2. Note Description Short
      3. Note Description Long
      4. Note Group ID
      5. Note Class ID
      6. Note Subclass ID
      7. Note and/or Note Attachments 1-N
         a. Owner/Submitted By ID
         b. Original Submission Date/Time
   b. Modifications 1-N
      1. Owner/Submitted By ID
      2. Modification Submission Date
      3. Short Description
      4. Long Description
         a. Owner/Submitted By ID
         b. Original Submission Date/Time
         c. Hyperlinks 1-N
         d. Change Image 1-N
         i. Before Change
         ii. After Change
24. Suppression Rules Database
25. Hyperlink Database
   a. Hyperlink ID
   b. Hyperlink
   c. Description
   d. Owner ID
   e. Advertiser ID
   f. Notes 1-N
26. User Database
   a. User ID
   b. Name
   c. Account Type
   d. Description
   e. Terms and Conditions ID
   f. Text
   g. Notes 1-N
27. Document Group Database
   a. Group ID
   b. Description
   c. Includes Sub-Groups/Sub-Class IDs 1-n
   d. Notes 1-N
28. Document Class
   a. Class ID
   b. Description
   c. Includes Sub-Class IDs 1-N
   d. Notes 1-N
29. Document Sub Class
   a. Subclass ID
   b. Description
   c. Notes 1-N
30. Note Class
   a. Note Class ID
   b. Description
   c. Includes Sub-Class IDs 1-N
   d. Notes 1-N
31. Note Subclass
   a. Note Subclass ID
   b. Description
   c. Notes 1-N
32. Nick Name Database
   a. Nick Name ID
   b. Nick Name (Short Description)
   c. Nick Name (Long Description)
   d. Patent or Document Number
   e. Notes 1-N
33. Patent Application or Document ID Database
   a. Patent or Document ID #
   b. Hyperlinks 1-N (e.g., Link to that patent on different websites)
   c. Notes 1-N
34. Alert Event Rules Database
   a. Alert Event Rule ID
   b. Alert Event Description
   c. Alert Event Rules 1-N
      1. Event Condition
      2. Alert Recipient ID 1-N
         a. Alert Method 1-N
      3. Alert Database ID 1-N
   d. Notes 1-N
35. Alert Database
   a. Alert Database ID
   b. Alert Contents, one or more of:
      1. Text
      2. Variable Data
      3. Executable
   c. Notes 1-N
36. Alert Methods Database
   a. Alert Method ID
   b. Method Type
   c. Delivery Method (cell phone, pager, e-mail, PDA, database, executable, etc.)
   d. Notes 1-N
37. Alert Recipient Database
   a. Alert Recipient ID (e.g., end user ID)
   b. Description
   c. Alert Method Preferences ID 1-N
   d. Notes 1-N

It will be appreciated that the various software and hardware components described above will be configured to perform a variety of functions and methods. Listed below are some exemplary methods that might be performed by the systems as described herein:

Select Words
1. Load Databases
2. Determine Advertisers
3. Determine Word Lists
4. Search Databases
5. Determine Words To Link to Advertisements
6. Determine Advertisements to Link to Words
7. Create Hyperlinks to Words
8. Update Databases

Track Clicks
1. Load Databases
2. Receive Indication of End User Click on Hyperlink
3. Redirect End User as required/indicated
4. Store Click Activity and Results
5. Update Database

Bill for Clicks
1. Load Databases
2. Determine Number/Type of Clicks by Advertiser
3. Determine Fees for Clicks
4. Create Invoice
5. Send Invoice to Advertiser
6. Update Databases

Determine Conversion
1. Receive a click on an advertisement
2. Receive an indication that a conversion has happened from the click
3. Store Click and Conversion
4. Retrieve clicks and conversion in a given time period
5. Generate and Store Conversion rate

Optimize Clicks
1. Receive and Store click data for keyword advertisements
2. Retrieve click rate data for various keyword clicks for a period of time
3. Categorize clicks in order of success
4. Generate queue or rules for placing later click advertisements based on keyword click success data
5. Output keywords on subsequent searches based on click success criteria

Optimize Conversion
1. Retrieve conversion rate data for various keyword clicks for a period of time
2. Categorize conversions in order of success
3. Generate queue or rules for placing later click advertisements based on keyword conversion success data
4. Output keywords on subsequent searches based on conversion success criteria

Bill for Conversion
1. Load Databases
2. Determine Number/Type of Conversions by Advertiser
3. Determine Fees for Clicks
4. Create Invoice
5. Send Invoice to Advertiser
6. Update Databases Create Word List Automated
7. Load Databases
8. Retrieve Synonyms and/or Antonyms
9. Determine Initial Relevancy Score
10. Update Databases

Create Word List Manual
1. Load Databases
2. Receive request to add/change/delete records
3. Retrieve Synonyms and/or Antonym submissions
4. If required, await approval of submissions
5. If approved, determine Initial Relevancy Score
6. Update Databases
7. Select Figures and Associate Advertisements to Figures
8. Load Databases
9. Retrieve Figure Database Names
10. Determine Words
11. Determine Applicable Advertisements
12. Create Hyperlinks
13. Update Databases

Create Word Hierarchy
1. Generate and Store word count and/or word search data
2. If applicable divide word counts by document class and subclass
3. Sort words by word count and/or word search data
4. Store word sort.

Create Word Groups
1. Generate word count occurrences of two or more words in documents that may be sorted by classes and subclasses
2. Score words based on occurrences of two or more words in a document
3. Create groups of words based on occurrence score and/or class and subclasses of documents where words occur

Create Advertisement Type
1. Retrieve a word or word group
2. Receive or Generate an advertisement type that is associated with the word or word group
3. Store Advertisement Type

Create Document Word Count
1. Load Databases
2. Search Documents
3. Count words requested by advertisers and/or included in documents
4. Update Databases

Create Word Click/Display Count
1. Load Databases
2. Receive Indication of End User Click Through
3. Determine if Advertisement is Displayed/Viewed
4. Update Databases

Create Survey
1. Load Databases
2. Determine Questions
3. Associate Questions with Hyperlinks
4. Update Databases Output Survey
5. Load Databases
6. Receive Indication of End User Click
7. Determine if Survey Required
8. If yes, present questions
9. Receive End User Responses
10. Determine if responses affect hyperlink action outcome
11. Redirect end user to appropriate hyperlink(s) or action(s)
12. Execute Billing Applications (e.g., click through and/or conversion billing)
13. Update Databases

Use Survey To Optimize word display, click, and conversion results
1. Retrieve one more more completed surveys
2. Score word display, click, and conversion results based on survey answers
3. Store Scores
4. Optimize and store word display rules based on scores.

Determine Advertisement Hyperlink for a displayed word
1. Receive a Keyword Search
2. Retrieve at least one document to display in response to keyword search
3. Determine words in document that have corresponding advertisements
4. Determine Advertisement Type
5. Generate appropriate hyperlink to word based on advertisement type
6. Output document with appropriate word hyperlinks

Create Survey to Provide More Information when Searchers Clicks on Hyperlink Word
1. Receive a Keyword Search
2. Output at least one document with at least one keyword hyperlink
3. Receive a click on the hyperlink
4. Generate and Output a survey in response to the keyword search and the hyperlink click
5. Receive Answers to the Survey
6. Generate one or more advertisements to display based on keyword search, hyperlink click, and survey answers.

Determine Advertisement List/Ranking/Queue for a hyperlinked word
1. Receive a Keyword Search
2. Generate at least one document with at least one hyperlink word in response to the keyword search
3. Determine at least two advertisements that are appropriate to display in response to clicking on the hyperlink.
4. Determine advertisement priority based on advertisement queue rules
5. Display advertisements in order of priority when hyperlink is pressed

Create Priority of Words
1. Receive a request to display an advertisement in response to clicking on one of a group of two or more words
2. Receive a priority ranking of the words
3. Store words with associated advertisement and priority ranking

Create Text Descriptors for Words
1. Receive a request to describe a word including a word, and a document class and subclass
2. Output Descriptor Form
3. Receive Description
4. Store description with word and document class/subclass

Display Text Descriptors for Words
1. Receive a Keyword Search
2. Generate at least one document with at least one word hyperlink in response to the keyword search
3. Determine text descriptor for hyperlinked word
4. Output Document
5. Receive Click on Hyperlink
6. Output text descriptor of word in response to hyperlink click

Create Synonyms and Antonyms for Words
1. Receive a request to create an advertisement for a word
2. Generate and Output a list of synonyms and antonyms for the word
3. Receive a request to link advertisement to at least one word listed as a synonym or antonym
4. Store Advertisement with Requested Word

Hyperlink word in document in document drafting tool
1. Receive a request to use a document drafting tool including a document type, class, and subclass
2. Receive or generate text to be included in document being drafted
3. Determine if advertisements exists for words included in text
4. Generate and output hyperlinks to words in text
5. Receive a click on a hyperlink
6. Display advertisement associated with hyperlinked word.

Hyperlink Word in Lexicon
1. Receive a request to use a lexicon including a document class and subclass
2. Display words in lexicon with corresponding definitions
3. Determine if advertisements are available for displayed words
4. Create hyperlinks to advertisements from displayed words
5. Receive a click on a hyperlink
6. Display Advertisement Associated with Hyperlink

Or Event Driven Models:

Create Maintain Databases
1. Initially populate or create empty databases
2. Update Databases

Primary Application
3. Load Databases
4. Receive indication that one or more applications/routines should be executed periodically, upon request, continually or based upon other indicator(s)
5. Execute such one or more applications/routines as desired/necessary
6. Update Databases

User Interface Application
1. Load database(s)
2. Display graphical user interface for each application/feature as requested/desired
3. Receive input or requests from applications, modules and/or end users
4. Execute functions as requested/required and/or load additional applications/GUIs
5. Update Databases

Opt In/Sign Up Application
1. Load Databases
2. Receiving indication of new user sign up
3. Record any and all or available information regarding one or more end users, merchants, advertisers, examiners, attorneys and/or third parties
4. Update Databases

Security Application
1. Load Database(s)
2. Determine if requested action and/or end user is permitted
3. If not, notify application and/or end user
4. If yes, permit requested step and/or loading of application or other authorized action(s)
5. Update Database(s)

End User Preferences Application
1. Load Databases
2. Present Preferences GUI if required
3. Receive End User Preferences/Feedback/Usage Tracking Information, including:
   a. Filter Criteria or Rules
   b. Sort Criteria or Rules
   c. Relevancy Information
   d. Weighting Factors, Criteria or Rules
   e. Security Preferences
   f. Feedback/Tracking Preferences
   g. Notes
   h. Usage habits/patterns
   i. Display preferences

Document Database Index Program
1. Load Databases
2. Determine Available or Participating Documents
3. Periodically search all available/participating documents
4. Create/update index for all found (or participating) documents /words/synonyms
5. Receive indication of add/change/delete request(s)
6. If required, queue and review request(s)
7. If required, approved request(s)
8. Create/Update Document Databases
9. Update Databases

Words Index Program
1. Load Databases
2. Search/Index all available documents
3. Create/update index for all words
4. Create/update/insert or maintain hyperlinks for all indexed words
5. Receive indication of add/change/delete request(s)
6. If required, queue and review request(s)
7. If required, approved request(s)
8. Determine and incorporate synonyms into index
9. Create/Update Word Database

10. Update Databases

Create/Maintain Advertising Database
1. Load Databases
2. Receive request to display one or more databases/words
3. Search for such databases/words
4. Display databases/words—sort and/or filter based upon end user preferences and/or survey responses—optionally use groups, classes or subclasses to sort/display information
5. Receive request to add or maintain or delete one or more advertisements
6. Determine word/document/hyperlink availability for ad insertion
7. Determine Pricing for Advertisements
8. If applicable, bill and/or collect and/or accrue fees
9. Create/update index for one or more advertisements
10. If required, queue and review request(s)
11. If required, approved request(s)
12. Insert advertising hyperlink to word or document database and/or source material
13. Create/Update Advertising Databases
14. Update Databases

Advertisement Creation/Submission Application
1. Load Database(s)
2. Display advertising creation/modification/submission GUI
3. Receive request to add/change/delete one or more advertisements
4. Receive advertisement or advertisement hyperlink contents and associate with one or more words, synonyms, antonyms and/or figures and/or documents
5. Determine if such one or more words, synonyms, antonyms, figures and/or documents have pre-existing hyperlinks by current or third party end user or otherwise
6. If not, determine price to associate hyperlink as applicable
7. If one or more similar hyperlinks already exist, execute hyperlink bid pricing application
8. If approved and priced, insert or otherwise associate said hyperlink with said one or more words, synonyms, antonyms, figures and/or documents.
9. Update Database(s)

Merchant/Advertiser Budget Program
1. Load Database(s)
2. Receive indication from advertiser for advertising budget, spending limits
3. Create budget/spending rules
4. Update Database(s)

Hyperlink Pricing Program
1. Load Database(s)
2. Receive Pricing Request
3. Determine if more than one user wishes a hyperlink to the same or similar word(s), synonym(s), antonym(s), figure(s) and/or documents
4. Determine pricing and/or auction hyperlink, or, if applicable, position in list of two or more hyperlinks
5. Notify affected parties, e.g., via an alert
6. Receive indication from one or more users as to willingness to pay and price points
7. Continue process until pricing is determined
8. Receive authorization for final pricing from affected parties, including end users
9. Update Database(s)

Advertisement Viewing/Use Application
1. Load Database(s)
2. Receive request to display or access advertisement, e.g., user clicks hyperlink or right clicks word
3. Determine if additional browser page or popup or other display method is to be used
4. Display Advertisement, e.g., load and display attached movie file
5. Determine if survey should be presented
6. Present Survey
7. Determine if secondary or different advertisement is to be displayed
8. Display Advertisement
9. Collect usage information, e.g., impressions for thesaurus relevancy and/or advertising/hyperlink click-through and/or conversion improvement and/or billing purposes

10. Execute Billing Program

11. Modify relevancy scores as determined by word, database and/or other application usage and/or using end user feedback

12. Update Database(s)

Word Definition/Synonym/Antonym/Figure/Document Lookup Tool
1. Load Database(s)
2. Receive request from advertising, hyperlink, drafting or third party display tool for word, definition, synonym, antonym, figure and/or document display (any one or any combination or all of the foregoing)
3. Determine Relevancy Information
4. Retrieve requested information, using relevancy information if applicable/available
5. Determine if additional browser page or popup or other display method is to be used (e.g., interstitial popup window)
6. Determine if application and/or end user has requested filter and/or sort and/or relevancy options
7. Display or Store Requested Information (using filter, sort and/or relevancy information and/or filter criteria if applicable//available)
8. Determine if survey should be presented
9. If presented, gather survey results

10. Determine if advertisement or supplemental information should be displayed

11. Display advertisement or supplemental information as indicated

12. Determine if relevancy information should be modified based upon any one or more of such surveys, advertisements, end user usage or any combination of these

13. Update Database(s)

Billing Program
1. Load Database(s)
2. Receive indication that billing activity has occurred
3. Determine affected parties, e.g., payer and payee
4. Determine billing rules, terms and conditions
5. Determine Billing Amounts Due
6. Create Invoice and A/P or A/R notices/entries
7. Send Invoices and notices
8. Update Databases
9. Await Payment

10. Receive Payment Indication

11. Apply Payments

12. Notify A/P or A/R systems/and/or affected parties

13. Determine if payments are timely/sufficient

14. If not, execute collections program

15. Update Database(s)

Collections Program
1. Receive indication payments are late and/or insufficient
2. Load Database(s)
3. If applicable, execute one or more of the following steps:
   a. Send late notice
   b. Send insufficient payment or funds notice
   c. Limit or prevent further use until payment terms are partially or fully satisfied, each according to billing terms and conditions and/or rules
   d. Collect funds due from primary and/or secondary credit cards on file.
   e. Notify affected parties
4. Update Database(s)

Create/Maintain Thesaurus
1. Load Databases
2. Create initial thesaurus by populating all known words
3. Periodically import known synonyms/antonyms
4. Receive add/change/delete and/or notes add/change/delete request
5. If required, queue and review request(s) and/or imported entries and/or notes
6. If required, approved request(s) and/or imported entries and/or notes
7. Add/Change/Delete synonym or antonym and/or entries and/or notes
8. If desired, add hyperlink in source or other databases to reference either or both the source word and/or the synonym or antonym and/or notes as applicable
9. Create/Update Thesaurus Database

10. Update Databases

Advertisement/Hyperlink Review Program
1. Load Databases
2. Determine Ad/Hyperlink Use/Effectiveness
3. Replace one or more underperforming ads/hyperlinks with one or more replacement hyperlinks
4. Monitor results of replacement ads/hyperlinks
5. Update effectiveness modeling or genetic algorithm
6. Update Databases

Alerts Program
1. Load Database(s)
2. Determine if Alert Event has occurred
3. Determine Alert Contents based upon alert rules
4. Determine Alert Recipients and Contents and Delivery Method(s)
5. Send Alert(s)
6. Update Database(s)

According to still further embodiments, the present disclosure provides a self teaching thesaurus that is configured to associate words and phrases based on user selection information. The user selection information may be obtained from a system such as that described above, configured to allow merchants or other entities to purchase the right to hyperlink one or more keyword in a database with a destination document.

According to one embodiment of the present disclosure, whenever two or more keywords are linked to the same destination document, the system is configured to automatically associate the two words as being related. For example, if a merchant that provides fishing gear rents the keywords “fishing pole” and “fishing rod” and links them to the same advertisement for fishing gear, the thesaurus system of the present disclosure learns that these two keywords are related. According to one embodiment, the system may enter the words into a database constructed for such purpose and indicate in the database that the words may be related.

As more end users, or merchants acquire rights in or to words and/or associate hyperlinks, e.g., advertisements, with such words and/or phrases, the system can expand and improve upon the database entries and identify more and more words as being generally or otherwise similar to other words similarly acquired or linked. Over time, the system can expand its database of entries to build a large repository of synonyms and/or antonyms.

The association between two or more keywords may be assigned a relevancy rating, indicating the degree of relationship—e.g. according to some systems of assigning relevancy, words that have a 100% relevancy rating are words that will always be considered exact synonyms. For example, the term “rod” and the term “pole” may have a lower relevancy, e.g., 70%, whereas the words “fishing rod” and “fishing pole” may be assigned a higher relevancy percentage, e.g., 90%. Such percentages or relevancy scores may be determined by any applicable means, including, but not limited to, based upon any one or more factors such as, the frequency a given merchant acquires rights in or to two or more words, in one or more databases and/or one or more documents and/or associates such words to the same or similar hyperlink and/or website and/or other document, web page, information, product, service, advertisement, message, note, application, module or plug-in, and/or the frequency one or more of the merchant's competitors acquire rights in and to the same or similar words and/or known or determined synonyms and/or link such words to similar products, goods, and services, and/or feedback provided by end users and/or merchants or any third party, for example, in response to one or more questions, e.g., survey questions, to determine such relevancy, or any combination of the foregoing. Acquisition of such survey responses may be made by any applicable means. In certain embodiments, relevancy scores may be determined, in whole or in part, through the use of manual and/or automated means. In addition to the novel relevancy ranking methods disclosed herein, other methods to determine relevancy between and among documents and/or websites are well known within the prior art, including, for example, the methods discussed in the book entitled “Text Databases and Document Management Theory and Practice, by Amita Goyal Chin. Furthermore, exemplary methods to request responses to survey questions are disclosed in U.S. Provisional Patent Application No. 60/774,177, and U.S. patent application Ser. Nos. 11/278,123, 11/562,738, 11/608,150 and PCT application No. PCT/US07/62172, each of which is hereby incorporated by reference.

Methods to create web pages, hyperlinks and hypertext are well known in the prior art and any person with ordinary skill in the art can design and create such hyperlinks. Methods to design and create hypertext and/or hyperlinks are discussed and disclosed by the authors of the following reference and other materials, including, for example: “Intelligent Hypertext: Advanced Techniques for the World Wide Web (Lecture Notes in Computer Science), by Charles Nicholas and James Mayfield,”“Information Architecture for the World Wide Web: Designing Large-Scale Web Sites [ILLUSTRATED], by Louis Rosenfeld (Author), Peter Morville,” Creating Web Pages with HTML Simplified, by Sherry Willard Kinkoph (Author),” “Master Visually Web Design (With CD-ROM) by Carrie F. Gatlin and Michael S. Toot,” and “Creating Internet Intelligence Wild Computing, Distributed Digital Consciousness, and the Emerging Global Brain (IFSR International Series on Systems Science and Engineering), by Ben Goertzel.” Each of these references is incorporated by reference.

According to some embodiments, the thesaurus may be presented or is otherwise made accessible to end users who (1) search the document database or (2) are preparing documents to include in the document database, or (3) desire to acquire rights in and/to the document and/or in or to one or more words and/or to insert or associate one on more hyperlinks with such one or more words and their website and/or other information or processes associated with such merchant and/or that is otherwise of interest or of benefit to such merchant, and/or (4) any merchant that pays or agrees to pay a fee for such access or use.

Furthermore, the thesaurus may also be presented to merchants who use only a subset of words that the thesaurus has identified as being related. In this way, merchants may opt to associate hyperlinks with more words.

As a further embodiment, merchants may associate advertisements with such one or more words. For example, a pop-up ad, roll over ad, or other advertisement may appear whenever an end user accesses a page in the document that contains a selected keyword.

In certain embodiments, the thesaurus may be initially and/or subsequently and/or periodically populated using existing or traditional resources such as a published thesaurus. An example of a commercially available thesaurus is Roget's Thesaurus. Use of preexisting resources can speed the initial creation and population of the database, as well as increase or aid in establishing accurate associations and/or may provide a means to help keep such database current. For example, when initially establishing a synonym database, the system may associate words that are identified as synonyms in a published thesaurus with a high degree of certainty, i.e., by assigning a 100% association or relevancy and/or by using some other ratio.

The system may or may not permit a modification to a relevancy assignment over time. For example, the word “book” maybe entered as a synonym in an existing thesaurus of the words “tome” “manuscript” and “volume,” etc. While the first two synonyms, i.e., tome and manuscript, may generally have a high relevancy to the word book, the word volume, may be assigned an initial or subsequently higher or lower relevancy. Such initial or subsequent assignment of relevancy may be made by any applicable means, including, for example, the existence of alternative initial or subsequent associations between other words, e.g., the word “volume” may also be associated with the words: “quantity” “amount” “degree” “size” “level” “number” and/or “sounds.” Based upon such degree and extent of other such synonyms and/or antonyms, the system may assign initial relevancy percentages based upon some non-equal percentage. In certain embodiments, such initial percentages may be retained on a temporary or permanent basis. In the cases where such initial percentages are retained permanently, the system may associate additional relevancy percentages with such word or words. In such fashion, the system is able to learn and determine or improve the accuracy of such percentages over time.

In contrast to other systems that identify synonymous and antonymous relationships based on “dictionary definitions,” the current system observes actions of users and identifies relationships based on behavioral commonalities rather than simply dictionary definitions. Accordingly, the disclosed system determines relationships between and among words that are based on real world use and input and that may not have obvious or other immediately apparent relationships. For example, in certain embodiments, the word “reel” may be associated with the word “pole” although one is not generally considered a synonym or antonym of the other. However, the system may determine that one or more users interested in and/or that review information or select or otherwise click on hyperlinks associated with the word “pole,” may also be generally interested or prompted to action by the word “reel.”

In certain embodiments, the system may assign multiple relevancy percentages, which may be determined by any applicable means and may include numerous such relevancy percentages. The system may track the relevancy of words within a document, multiple documents, classes, sub-classes or categories of documents, classes of trade, and/or organized by any other applicable means. For example, the relevancy of the words volume and dimensions in the context of or used within a book regarding stereo systems may be low, while, the same words, i.e., volume and dimensions may carry a higher relevancy when used in the context of a book on geometry or shipping containers. Relevancy percentages may be initially established and/or modified over time. The number tracked may be fixed, e.g., two (i.e., one for the initial setting and one for variable or modifiable settings) or unlimited, e.g., the number of relevancy scores may be determined by any applicable means, including, for example, the number of different merchants vying for the same or similar words but perhaps belonging to entirely different classes of trade.

In addition to or as an alternative to generating a thesaurus of keywords, the system can also use the merchant selection of documents and keywords to map documents together as being similar or dissimilar. The system creates a new classification system of the documents based on which documents certain merchants purchase keywords and/or based upon actual end user usage over time.

According to yet another embodiment, the thesaurus can also be added to or otherwise revised by other end users or merchants or other third parties who can type additional text into a notes system and/or provide feedback via usage of a survey application. Such notes, survey responses, feedback and/or revisions or access may require such end users, merchants or other third parties to obtain permission or other authorizations.

Such feedback, notes, modifications and/or survey question responses may or may not require the end user to submit a form of identification, e.g., user name, actual name, driver's license, passport number, etc. Exemplary methods to provide for such feedback and or notes and or survey response questions are disclosed in U.S. patent application Ser. Nos. 11/697,480, 11/278,123, 11/562,738, 11/608,150 and PCT Application Serial Nos. PCT/US07/62172, and PCT/US07/66687 each of which are hereby incorporated by reference.

According to yet another embodiment, search engines can use the thesaurus to link additional documents to the original documents. End users can search these from a GUI provided with the display of the original document and/or that provided by such search engine(s), e.g., Google and Yahoo. Additional search engine improvements may be incorporated into new or existing search engines to permit further end user control or added benefits. Selected methods to improve an existing search engine, that permit feedback and other end user interaction are disclosed in U.S. patent application Ser. Nos. 11/671,381, 11/693,555, 11/697,447 and PCT Application Serial No. PCT/US07/66702, each of which are hereby incorporated by reference.

According to yet another embodiment, a report of like documents can be prepared for an end user who is using the thesaurus to draft a document that can be contributed to the database of documents. This report can be edited and submitted to the database provider along with the drafted document. In certain embodiments, end users and/or merchants can provide feedback and/or include notes using methods hereinabove described. Such notes and/or feedback can be used to affect relevancy scores, update reports, and/or assist end users, merchants and/or third parties to determine if certain keywords or documents are of general or specific interest, and/or to provide information to enable improvements to the system's relevancy calculation methods, for example, such feedback and/or survey responses may be used in whole or in part by any applicable means, including, for example, a learning system, e.g., a neural net and/or genetic algorithm, etc. Using such learning systems or reporting, the system may improve it's methods for making such relevancy scores and/or reports used for such analysis or calculations, which calculations may be based, in whole or in part on any known statistical calculation method, e.g., weighted averaging, and/or any such learning systems.

Use and applications of rules based, expert systems and/or genetic algorithms are well known in the prior art and may be implemented using any applicable means. For example, methods to develop rules, expert systems and/or genetic algorithms are discussed and disclosed in various issued and pending patents and reference and other materials, including the following books entitled: “Genetic Algorithms in Search, Optimization, and Machine Learning”, by David E. Goldberg, and “An Introduction to Genetic Algorithms,” by Melanie Mitchell, and “Expert Systems: Design and Development,” by John Durkin,” and “Logical Foundations for Rule-Based Systems (Studies in Computational Intelligence),” by Antoni Ligeza, each and all of which are incorporated herein by reference.

According to yet another embodiment, the advertisements, e.g., the words and/or notes and/or hyperlinks, that merchants type and link to keywords may also used to build the thesaurus and lexicon and/or may be used to affect one or more relevancy scores. In addition or in the alternate, keyword search results and information owned or gathered by new or existing search engines, such as Google and Yahoo, may be used to create, modify, expand or otherwise improve the thesaurus and/or lexicon and/or any relevancy scores and/or initial or subsequent placement of any one or more hyperlinks and/or may be used to create, modify, and/or maintain any new or existing pricing models and/or methods to provide for one or more interrelationships by or between any such new or existing search engines and/or said hyperlinks, lexicon, thesaurus and/or tools or other methods disclosed herein.

In certain embodiments, before displaying an advertisement and/or before presenting a list of words and/or documents, e.g., from a lexicon of words, it may be desirable to ascertain certain additional information about such advertisement and/or request for information. In such cases, the system may determine that it is necessary, desirable or generally useful to present one or more survey questions to aid in determining which words, documents, or other information should be presented, e.g., to help determine which advertisement might yield generally better results, and/or which word or synonym is generally more relevant given the information known about the end user and/or collected by using and/or displaying and/or gathering results from one or more such survey questions. For example, when an end user enters the word “case” into a search tool designed to retrieve a definition of such word or words, the system might ask the end user the following question or questions: e.g., are you an attorney, are you interested in travel, or are you seeking legal advice. Based upon the end user's response, e.g., if the end user responded in the affirmative to the last question, the system might either provide a definition of case to include legal cases, and/or the system may also provide an advertisement for one or more attorneys seeking clients. Based upon the response to one or more questions, the system may present additional qualifying questions, i.e., additional questions to further narrow the search results and or the sort display results. Exemplary methods to provide for such survey questions in response to an end users search query are provided by applicant's patent application were incorporated by reference above.

In the event that one or more relevancy scores change over time, such changes may affect the fee paid by one or more merchants and/or the frequency such merchant's hyperlink(s) appear or are otherwise made available or activated. For example, if a given word's relevancy or usefulness to a given merchant increases over time, for example, because such word's hyperlink is used more frequently or is proven to be successful in driving business to a given merchant, then such word's relevancy score may be increased and, one or more fees charged to such merchant(s) may be increased therefore and/or the frequency such hyperlink is displayed or made available may increase accordingly.

In certain embodiments, when any relevancy score is changed and/or a note is attached or changed, and/or a new synonym or antonym is added or updated within the thesaurus and/or a new merchant offers to pay a fee or a higher fee than the existing fee and/or one or more merchant's opt to remove a link and/or add a link or hyperlink to or otherwise associate with one or more words, and/or any other change within the disclosed system, its database, rules, scores, frequency of hyperlink display, order of such display, or any other action or inaction is taken or fails to occur, the system disclosed may send one or more notices of any such addition or change to any affected or interested parties, which may include end users, merchants or any person or third party. Such notice may be provided by any applicable means. For example, an end user or merchant may be alerted that a change has occurred or has been submitted to one or more words in the thesaurus or lexicon. Such end user or merchant may be alerted via any applicable means, for example, via email message or popup instant message. In certain embodiments, such definitions may be submitted and/or attached and/or mapped by using notes or hyperlinks. Exemplary methods for sending such alerts are disclosed by applicant's co-pending patent application Ser. No. 11/676,848, which is hereby incorporated by reference.

Those having skill in the art will recognize that there is little distinction between hardware and software implementations. The use of hardware or software is generally a choice of convenience or design based on the relative importance of speed, accuracy, flexibility and predictability. There are therefore various vehicles by which processes and/or systems described herein can be effected (e.g., hardware, software, and/or firmware) and that the preferred vehicle will vary with the context in which the technologies are deployed.

At least a portion of the devices and/or processes described herein can be integrated into a data processing system with a reasonable amount of experimentation. Those having skill in the art will recognize that a typical data processing system generally includes one or more of a system unit housing, a video display device, memory, processors, operating systems, drivers, graphical user interfaces, and application programs, interaction devices such as a touch pad or screen, and/or control systems including feedback loops and control motors. A typical data processing system may be implemented utilizing any suitable commercially available components to create the gaming environment described herein.

Accordingly, the presently described system may comprise a plurality of various hardware and/or software components such as those described below. It will be appreciated that for ease of description, the variously described hardware and software components are described and named according to various functions that it is contemplated may be performed by one or more software or hardware components within the system. However, it will be understood that the system may incorporate any number of programs configured to perform any number of functions including, but in no way limited to those described below. Furthermore, it should be understood that while, for ease of description, multiple programs and multiple databases are described, the various functions and/or databases may, in fact, be part of a single program or multiple programs running in one or more locations.

FIG. 4 provides an exemplary systems diagram of a system 400 that may be configured to perform the functions described here. As shown, system 400 may include a:

1. Thesaurus Generation Program 402

2. Display Program 404

3. Search Program 406

4. Billing Program 408

5. Certification Program 410

6. Note Program 412

System 400 may further comprise a plurality of databases 414. It will be understood that the specific databases needed in system 400 (or to which system 400 should or would have access) will generally be determined based on the capacity and intended use of the system. Accordingly, exemplary database architectures include:

Word Database

1. Word ID

a. Word Count ID

b. Word

c. Primary Definition

d. Hyperlinks 1-N (e.g., sources/locations of use)

e. Alternative Definitions 1-N

1. Definition

2. Supplied By—ID

3. Hyperlinks 1-N

f. Synonym ID-1-N

1. Synonym

2. Word ID

3. Relevancy Scores 1-N

4. Primary Score %

5. Alternative Score %'s 1-N

g. Antonym ID-1-N

1. Antonym

2. Word ID

3. Relevancy Scores 1-N

4. Primary Score %

5. Alternative Score %'s 1-N

h. Notes 1-N

1. Note ID

2. Note Short Description

3. Note Long Description

4. Narrative Text

5. Attachment Hyperlinks 1-N

6. Where Used Hyperlinks 1-N

i. Figure IDs 1-N

j. Change Tracking ID 1-N

Change Tracking Database

1. Change Tracking ID

2. Word ID

3. Change Type (e.g., Add, change, delete)

4. Change Description

5. Date/Time

6. User ID

7. Before Image

8. After Image

9. Relevancy or Score

10. Notes 1-N

Figure Database

1. Figure ID

2. Figure Description

3. Figure or Attachment

4. Submitted By ID

5. Source ID

6. Editor Application ID

7. Document/Patent Application Where Used ID 1-N

a. Hyperlinks 1-N

8. Notes 1-N

Document Database

1. Document ID

a. Document Description

b. Document Owner ID

c. Hyperlinks (e.g., document locations) 1-N

d. Class 1-N

e. Subclass 1-N

f. Type 1-N

g. Subtype 1-N

h. Date/Time Stamps

1. Submitted/Found/Indexed On

2. Submitted/Found/Indexed By ID or Hyperlink

3. Revised On 1-N

4. Revised By 1-N

5. Before Image 1-N

6. After Image 1-N

2. Notes 1-N

Advertiser or Notes Owner Database

1. Advertiser/Owner ID

2. Advertiser/Owner Name

3. Classes of Trade 1-N

4. Advertiser/Owner Financial Information

a. Billing Method ID

b. Credit Card Information

1. Preferred Card Number

2. Preferred Card Holder

3. Preferred Card Type

4. Name

5. Expiration Date

6. Security Code

c. Additional Cards 1-N

1. Card Number

2. Card Holder (e.g., Bank Name)

3. Card Type (e.g., Visa)

4. Name

5. Expiration Date

6. Security Code

5. Advertiser/Note Owner Mailing Address

6. Advertiser/Note Owner Rules Database

a. Rule ID 1-N

1. Word(s)/Documents Applied To 1-N

a. Rule Description

b. Rules 1-N

c. Billing Terms and Conditions ID 1-N

7. Advertiser/Note Owner Attorney of Record

a. Attorney ID 1-N

8. Advertiser/Note Owner Qualifications 1-N

9. Notes 1-N

Advertiser/Note Owner Qualifications Database

1. Qualification ID

2. Description

3. Qualification Type

4. Years Experience

5. Fields of Use Applicable 1-N

6. Notes 1-N

Attorney Database

1. Attorney ID

2. Name

3. Address

4. Description

5. Billing Terms and Conditions Database

6. Billing Method ID

7. Billing Type

8. Description

9. Billing Frequency

10. Due by # days

11. Late by # days

12. Interest Rate Fixed

13. Interest Rate Variable

14. Interest Accrues after days

15. Notes 1-N

Accounts Receivable Database

1. Advertiser/Note Owner ID

Total Amount Owed

a. Transaction Detail Records 1-N

1. Date of Transaction

2. Type

3. Advertisement ID

4. Word ID

5. Hyperlinks 1-N

6. Amount per impression or click through

Search Database

1. Document ID

2. Document Location/Hyperlink

3. Notes 1-N

Transaction Database

1. Transaction ID

2. Description

3. Date/Time

4. Type

5. Advertiser/Note Owner ID

6. Advertisement/Note Owner Rules Used 1-N

7. Billing T&C's 1-N

8. Billing Method ID

9. Transaction Amount

10. Results 1-N

a. Note Added, Changed, Deleted, and/or Accessed

b. Hyperlink Clicked

c. Sub-Hyperlinks Clicked 1-N

1. Advertisement/Note and/or Webpage) Displayed 1-N

2. Click Through y/n

3. Duration of View

4. Conversion Y/N

5. Conversion Dollar Amount

11. Notes 1-N

Advertisement Database

1. Advertisement ID

2. Advertiser ID

3. Description

4. Words 1-N

5. Documents 1-N

6. Hyperlinks 1-N

7. Advertising Content File 1-N

8. Notes ID 1-N

9. Start/Stop Dates/Times

Document Class Database

1. Class ID

2. Description

3. Notes 1-N

Document Sub Class Database

1. Subclass ID

2. Description

3. Notes 1-N

Document Type Database

1. Type ID

2. Description

3. Notes 1-N

Document Sub Type Database

1. Subtype ID

2. Description

3. Notes 1-N

Group Database

1. Group ID

2. Description

3. Notes 1-N

Advertisement Type Database

1. Type ID

2. Description

3. Notes 1-N

Word Count Database

1. Word ID

2. Number of Occurrences

3. Hyperlinks 1-N

4. Notes 1-N

Survey Database

1. Survey ID

2. Survey Description

3. Advertiser ID

4. Survey Question ID 1-N

a. Question

b. Answer Options 1-N

5. Notes 1-N

Results Database

1. Result ID

2. End User ID

3. Survey Questions 1-N

4. Survey Answers 1-N

5. Date/Time Stamp

6. Narrative or Text Responses 1-N

7. Notes 1-N

Rules Database

1. Rule ID

2. Rule Description

3. Rules 1-N

4. Notes 1-N

Search and Survey Database

Word Descriptor Database

Notes Database

1. Note ID

a. Hyperlinks 1-N

b. Note Description Short

c. Note Description Long

d. Note Group ID

e. Note Class ID

f. Note Subclass ID

g. Note and/or Note Attachments 1-N

1. Owner/Submitted By ID

2. Original Submission Date/Time

2. Modifications 1-N

a. Owner/Submitted By ID

b. Modification Submission Date

c. Short Description

d. Long Description

1. Owner/Submitted By ID

2. Original Submission Date/Time

3. Hyperlinks 1-N

4. Change Image 1-N

a. Before Change

b. After Change

3. Notes 1-N

Suppression Rules Database

Hyperlink Database

1. Hyperlink ID

2. Hyperlink

3. Description

4. Owner ID

5. Advertiser ID

6. Notes 1-N

User Database

1. User ID

2. Name

3. Account Type

4. Description

5. Terms and Conditions ID

6. Text

7. Notes 1-N

Document Group Database

1. Group ID

2. Description

3. Includes Sub-Groups/Sub-Class IDs 1-n

4. Notes 1-N

Document Class

1. Class ID

2. Description

3. Includes Sub-Class IDs 1-N

4. Notes 1-N

Document Sub Class

1. Subclass ID

2. Description

3. Notes 1-N

Note Class

1. Note Class ID

2. Description

3. Includes Sub-Class IDs 1-N

4. Notes 1-N

Note Subclass

1. Note Subclass ID

2. Description

3. Notes 1-N

Nick Name Database

1. Nick Name ID

2. Nick Name (Short Description)

3. Nick Name (Long Description)

4. Patent or Document Number

5. Notes 1-N

Patent Application or Document ID Database

1. Patent or Document ID #

2. Hyperlinks 1-N (e.g., Link to that patent on different websites)

3. Notes 1-N

Alert Event Rules Database

1. Alert Event Rule ID

2. Alert Event Description

3. Alert Event Rules 1-N

a. Event Condition

b. Alert Recipient ID 1-N

1. Alert Method 1-N

c. Alert Database ID 1-N

4. Notes 1-N

Alert Database

1. Alert Database ID

2. Alert Contents, one or more of:

a. Text

b. Variable Data

c. Executable

3. Notes 1-N

Alert Methods Database

1. Alert Method ID

2. Method Type

3. Delivery Method (cell phone, pager, e-mail, PDA, database, executable, etc.)

4. Notes 1-N

Alert Recipient Database

1. Alert Recipient ID (e.g., end user ID)

2. Description

3. Alert Method Preferences ID 1-N

4. Notes 1-N

Merchant Database

1. Merchant ID

2. Name

3. Address

4. Shipping Information

5. Billing Information

6. Billing T&Cs ID

7. Classes of Trade IDs 1-N

8. Advertisement IDs 1-N

9. Notes 1-N

Thesaurus Database

1. Word ID#

2. Entry Type (e.g., Synonym or Antonym)

3. Word ID #

4. Notes 1-N

Thesaurus Creation Rules Database

1. Rule ID #

2. Description

3. Uses

4. Limitations

5. Rules 1-N

6. Notes 1-N

Word Class Database

1. Class ID

2. Description

3. Notes 1-N

4. Includes Sub-classes 1-N

5. Notes 1-N

Word Subclass Database

1. Sub-class ID

2. Description

3. Notes 1-N

4. Notes 1-N

Phrase Class Database

1. Class ID

2. Description

3. Includes Sub-classes 1-N

4. Notes 1-N

Phrase Subclass Database

1. Sub-class ID

2. Description

3. Notes 1-N

Word Count Database

1. Word ID

2. Word Count

3. Word Usage Tracking 1-N (e.g., hyperlinks)

4. Notes 1-N

Relevancy Percentage Database

1. Relevancy ID #

2. Word or Document #

3. Related Word or Document # 1-N

4. Percentages 1-N

5. Notes 1-N

Map Database

1. MapID#

2. Description

3. Notes 1-N

4. Source Document ID #

a. Source Words ID # 1-N

b. Map references (sources) ID 1-N

c. Map references (nodes) ID 1-N

d. Map references (other) ID 1-N

e. Related Document or Word ID # 1-N

1. Type ID (e.g., word or document, etc.)

2. Related Document or Word ID # 1-N

3. Related Document or Word ID Relevancy Score, %, or Rank

4. Map references (sources) ID 1-N

5. Map references (nodes) ID 1-N

6. Map references (other) ID 1-N

7. Notes 1-N

5. Notes 1-N

Thesaurus Notes Database

1. Thesaurus Note ID

2. Notes 1-N

IDS Database

1. IDS ID#

2. IDS Document (text or document attachment)

3. Notes 1-N

It will be appreciated that the various software and hardware components described above will be configured to perform a variety of functions and methods. Listed below are some exemplary methods that might be performed by the systems as described herein:

Create and Track Merchant Word Selections and Associated Advertisements

a. Receive a keyword from a merchant including a document class and subclass

b. Receive an advertisement to associate with the keyword

c. Receive an additional keyword from a merchant

d. Receive an indication that the advertisement was associated with the additional keyword

e. Store keywords and associated advertisements

Receive Document Creation Requests and Output Thesaurus

a. Receive a request to create a document including a document class and subclass

b. Determine words in document class and subclass

c. Associate words based on common advertisements associated with words

d. Generate and output word thesaurus based on class, subclass and associated advertisements

Optimize Thesaurus Based on Word Selections/Use

a. Receive an indication of use of a word in the thesaurus

b. Store thesaurus usage

c. Generate usage score for each word used

d. Generate list of relevant words organized/optimized based on scores

e. Output optimized list of words in subsequent Thesaurus sessions including scores

Update Online Thesaurus with Standard Thesaurus

a. Retrieve a standard thesaurus

b. Retrieve an online thesaurus generated based on advertisements associated with words

c. Enhance online thesaurus with standard thesaurus data

d. Store enhanced thesaurus for subsequent session use.

Update Standard Thesaurus with Online Thesaurus

a. Retrieve a standard thesaurus

b. Retrieve an online thesaurus generated based on advertisements associated with words

c. Enhance standard thesaurus with enhanced thesaurus data

d. Store enhanced thesaurus for subsequent session use.

Assign Relevancy % or Rank

a. Retrieve all word associations based on common advertisements

b. Score word associations based on number of common advertisements

c. Sort word associations based on number of common advertisements

d. Create and store word association list including sort and score

Create Document Map

a. Retrieve all advertisements associated with a document

b. Create and store document map of advertisements

Create Multiple Document Map

a. Retrieve a document map including words with associated advertisements

b. Create a document association based on map

c. Score documents based on document association

d. Store document scores

Add Notes to Thesaurus

a. Output thesaurus

b. Receive a request to add a note to a thesaurus entry

c. Receive note data

d. Store note data with thesaurus entry

e. Mark note data a “uncertified”

Certify Thesaurus

a. Receive certifier log in

b. Retrieve and output uncertified thesaurus data

c. Receive indication that thesaurus is certified

d. Mark thesaurus data as “certified”

Certify Thesaurus Notes

a. Receive certifier log in

b. Retrieve and output uncertified thesaurus note data

c. Receive indication that thesaurus note is certified

d. Mark note data as “certified”

Create Search Enhancement

a. Receive a common search word including class and subclass

b. Generae a list of associated words based on advertisement associations

c. Store associated words

Output Search Enhancement

a. Receive a search word

b. Determine if there are words associated with the search word

c. Output associated words in response to search word

d. Receive additional word selections from associated words

e. Modify search based on additional word selection

Create IDS Report

a. Receive Patent Data

b. Compare Patent Data to Document Maps

c. Compile Relevant Documents to Patent Data based on document maps

d. Generate IDS report of Relevant Documents

Determine Relevancy Score

a. Receive Patent Data

b. Compare Patent Data to Document Maps

c. Score Document Map Data to Patent Data based on scoring criteria

d. Store Relevancy Score with Document Maps for Patent Data

Use Advertisements to Create and or Enhance Thesaurus

a. Retrieve advertisements and associated words

b. Generate thesaurus based on advertisements and associated words

c. Store Thesaurus

Use Survey Questions to improve advertising results

a. Receive a click on a hyperlinked word

b. Retrieve/Generate a survey in response to the click

c. Receive a response to the survey

d. Generate at least one advertisement in response to the click and the survey response

e. Receive a click on the advertisement.

f. Store click

Alter Hyperlinks based on Criteria

a. Retrieve hyperlink click data

b. Score hyperlink click success rates

c. Modify hyperlink word selection based on click success rates (for example, stop linking an advertisement to a word, if no one clicks on the advertisement.)

Alert Users to Change in Status of Hyperlink

a. Determine that a hyperlink status has been changed (for example, the hyperlink to an advertisement has been disabled)

b. Generate a group of parties to notify

c. Notify parties that hyperlink has changed status

Create Maintain Databases

1. Initially Populate or create empty databases

2. Update Databases

Primary Application

1. Load Databases

2. Receive indication that one or more applications/routines should be executed periodically, upon request, continually or based upon other indicator(s)

3. Execute such one or more applications/routines as desired/necessary

4. Update Databases

Security Application

a. Load Database(s)

b. Determine if requested action and/or end user is permitted

c. If not, notify application and/or end user

d. If yes, permit requested step and/or loading of application or other authorized action(s)

e. Update Database(s)

End User Preferences Application

1. Load Databases

2. Present Preferences GUI if required

3. Receive End User Preferences/Feedback/Usage Tracking

Information, including:

a. Filter Criteria or Rules

b. Sort Criteria or Rules

c. Relevancy Information

d. Weighting Factors, Criteria or Rules

e. Security Preferences

f. Feedback/Tracking Preferences

g. Notes

h. Usage habits/patterns

i. Display preferences

Opt In/Sign Up Application

1. Load Databases

2. Receiving Indication of new user sign up

3. Record any and all or available information regarding one or more patent applicant's, end users, examiners, attorneys and/or third parties

4. Update Databases

Create/Maintain Document Database

1. Load Databases

2. Determine Available or Participating Documents

3. Periodically Search all Available Documents

4. Create/update index for all found (or participating) documents

5. Receive indication of add/change/delete request(s)

6. If required, queue and review request(s)

7. If required, approved request(s)

8. Create/Update Document Databases

9. Update Databases

Create/Maintain Words Database

1. Load Databases

2. Search/Index all available documents

3. Create/update index for all words

4. Create/update/insert or maintain hyperlinks for all indexed words

5. Receive indication of add/change/delete request(s)

6. If required, queue and review request(s)

7. If required, approved request(s)

8. Create/Update Word Database

9. Update Databases

Create/Maintain Advertising Database

1. Load Databases

2. Receive request to add or maintain or delete one or more advertisements

3. Create/update index for all advertisements

4. If required, queue and review request(s)

5. If required, approved request(s)

6. Insert advertising hyperlink to word or document database and/or source material

7. Create/Update Advertising Databases

8. Update Databases

Advertisement Creation Application

1. Load Database(s)

2. Display advertising creation/modification GUI

3. Receive request to add/change/delete one or more advertisements

4. Receive advertisement hyperlink contents and associate with one or more words, synonyms, antonyms and/or figures and/or documents

5. Determine if such one or more words, synonyms, antonyms, figures and/or documents have pre-existing hyperlinks by current or third party end user or otherwise

6. If not, determine price to associate hyperlink as applicable

7. If one or more similar hyperlinks already exist, execute hyperlink bid pricing application

8. If approved and priced, insert or otherwise associate said hyperlink with said one or more words, synonyms, antonyms, figures and/or documents.

9. Update Database(s)

Hyperlink Pricing Program

1. Load Database(s)

2. Receive Pricing Request

3. Determine if more than one user wishes a hyperlink to the same or similar word(s), synonym(s), antonym(s), figure(s) and/or documents

4. Determine pricing and/or auction hyperlink, or, if applicable, position in list of two or more hyperlinks

5. Notify affected parties, e.g., via an alert

6. Receive indication from one or more users as to willingness to pay and price points

7. Continue process until pricing is determined

8. Receive authorizing for final pricing from affected parties, including end users

9. Update Database(s)

Advertisement Viewing/Use Application

1. Load Database(s)

2. Receive request to display or access advertisement, e.g., user clicks hyperlink or right clicks word

3. Determine if additional browser page or popup or other display method is to be used

4. Display Advertisement, e.g., load and display attached movie file

5. Determine if survey should be presented

6. Present Survey

7. Determine if secondary or different advertisement is to be displayed

8. Display Advertisement

9. Collect usage information, e.g., impressions for thesaurus relevancy improvement and billing purposes

10. Modify relevancy scores as determined by word, database and/or other application usage and/or using end user feedback

11. Update Database(s)

Word Definition/Synonym/Antonym/Figure/Document Lookup Tool

1. Load Database(s)

2. Receive request from drafting or third party display tool for word, definition, synonym, antonym, figure and/or document display (any one or any combination or all of the foregoing)

3. Determine Relevancy Information

4. Retrieve requested information, using relevancy information if applicable/available

5. Determine if additional browser page or popup or other display method is to be used (e.g., interstitial popup window)

6. Determine if application and/or end user has requested filter and/or sort and/or relevancy options

7. Display Requested Information (using filter, sort and/or relevancy information and/or filter criteria if applicable//available)

8. Determine if survey should be presented

9. If presented, gather survey results

10. Determine if advertisement or supplemental information should be displayed

11. Display advertisement or supplemental information as indicated

12. Determine if relevancy information should be modified based upon any one or more of such surveys, advertisements, end user usage or any combination of these

13. Update Database(s)

Document Submission/Filing Application

1. Load Database(s)

2. Receive request to submit document with words, synonyms, antonyms, figures and/or related documents to database, repository or processing agency, e.g., USPTO

3. Capture image of all relevant materials, including then current definitions, along with Time/Date stamp information

4. If desired, encrypt any or all output materials, e.g., patent application, definitions, words, synonyms, antonyms, figures and/or related documents and/or supporting materials to prevent or otherwise control subsequent access and/or modifications

5. Update Database(s)

Mapping Program

1. Load Databases

2. Receive indication that one or more words, synonyms, antonyms and/or documents have been added or changed or removed from one or more databases

3. Receive or Determine Relevancy Information

4. Determine mapping relationships among the foregoing

5. Monitor word, synonym, antonym, document and/or mapping usage

6. Receive feedback from end users and/or determine change in mapping relationships and/or relevancy

7. If desired or required, submit any such changes for review/approval

8. If approved, update mapping relationship data accordingly

9. Update Databases

End User Contest Application

1. Load Database(s)

2. Receive Indication that one or more end users and/or third parties, e.g., patent examiner, contests one or more word definitions, words, synonyms, antonyms, figures and/or other documents, maps and/or supporting materials

3. Determine relevancy/validity of the contest by any one or all of the following if desired/applicable

a. Solicit other end user/third party votes/scores/ranking

b. Use GA

c. Submission to authorized end user or third party

d. Preponderance of feedback

4. If contest is determined valid, accept requested changes

5. Otherwise Reject Requested Changes

6. Update Database(s)

Billing Program

a. Load Database(s)

b. Receive indication that billing activity has occurred

c. Determine affected parties, e.g., payer and payee

d. Determine billing rules, terms and conditions

e. Determine billing amounts due

f. Create Invoice and A/P or A/R notices/entries

g. Send Invoices and notices

h. Update Databases

i. Await Payment

j. Receive payment indication

k. Apply payments

l. Notify A/P or A/R systems/and/or affected parties

m. Determine if payments are timely/sufficient

n. If not, execute collections program

o. Update Database(s)

Collections Program

a. Receive indication payments are late and/or insufficient

b. Load Database(s)

c. If applicable, execute one or more of the following steps:

1. Send Late Notice

2. Send insufficient payment or funds notice

3. Limit or prevent further use until payment terms are partially or fully satisfied, each according to billing terms and conditions and/or rules

4. Collect funds due from primary and/or secondary credit cards on file.

5. Notify Affected Parties

d. Update Database(s)

Create/Maintain Thesaurus

1. Load Databases

2. Create initial thesaurus by populating all known words

3. Periodically import known synonyms/antonyms

4. Receive add/change/delete and/or notes add/change/delete request

5. If required, queue and review request(s) and/or imported entries and/or notes

6. If required, approved request(s) and/or imported entries and/or notes

7. Add/Change/Delete synonym or antonym and/or entries and/or notes

8. If desired, add hyperlink in source or other databases to reference either or both the source word and/or the synonym or antonym and/or notes as applicable

9. Create/Update Thesaurus Database

10. Update Databases

Thesaurus Word Use Tracking

1. Load Databases

2. Receive indication of word or associated word use

3. Receive end user or other feedback/relevancy scores

4. Determine optimal relevancy scores based upon word use and/or feedback

5. Modify Relevancy Percentage

6. Update Databases

Document/Word Map Creation/Maintenance Program

1. Load Databases

2. Determine Word/Document Relevancy

3. Create relevancy map based upon relevancy scores and feedback and/or manual mapping activities

4. Create/Update Word/Document maps

5. Update Databases

User Interface Application

1. Load database(s)

2. Display graphical user interface for each application/feature as requested/desired

3. Receive Input from End Users

4. Execute functions as requested/required and/or load additional applications/GUIs

5. Update Databases

Create/Update IDS Database and Reporting

1. Load Databases

2. Import or receive one or more IDS submissions

3. If required, queue IDS for review/approval

4. If approved add to database, otherwise reject IDS

5. Periodically search, index and review IDS Database

6. Create IDS report

7. Distribute and/or submit report to interested/affected parties

8. Update Databases

Survey Program

1. Load Databases

2. Receive indicator that relevancy information should be updated

3. And/or periodically submit one or more survey questions to one or more end users

4. Determine questions based upon survey database rules and/or based upon prior effectiveness of one or more survey questions

5. Determine respondent or target end users

6. Submit questions to respondent(s)

7. Receive Results

8. Determine New Relevancy Scores

9. Update relevancy information and/or modify hyperlinks or advertisements based upon new or revised relevancy scores and/or other end user feedback

10. And/or use GA to determine relevancy scores and/or hyperlink and/or advertisements

11. Update Databases

Hyperlink Review Program

1. Load Databases

2. Determine Hyperlink Use/Effectiveness

3. Replace one or more underperforming hyperlinks with one or more replacement hyperlinks

4. Update Databases

Certification Program

1. Load Databases

2. Present Thesaurus, Notes, Advertisements and other Add/Changes /Delete requests and/or feedback to one or more authorized examiners/reviewers/peer review group(s)

3. Receive indication of reject or acceptance of such additions/changes /deletions, or other change requests and/or feedback.

4. If rejected, notify submitter(s)

5. If accepted, notify submitter(s) and update databases as applicable

6. Update Databases

Alerts Program

1. Load Database(s)

2. Determine if Alert Event has occurred

3. Determine Alert Contents based upon alert rules

4. Determine Alert Recipients and Contents and Delivery Method(s)

5. Send Alert(s)

6. Update Database(s)

According to yet another embodiment, the present disclosure provides a database including embedded advertisements or links to advertisements. In one specific embodiment, the database may be a database of patent documents including, for example, pending patent applications or issued patents, such as those described above. Frequently, users who search a database of invention disclosures, such as a patent office database, are interested in products related to the inventions disclosed in the database. For example, at one time or another most people have thought to themselves “I'd love to find a ______ that does ______ or includes a ______.” In such a circumstance, an individual may search an invention disclosure database to see if the idea has previously been protected, thinking they might try to obtain protection themselves for the idea. However, since the individual's ultimate goal is frequently to obtain a product with the desired features, it would be extremely beneficial to also provide advertisements for products having the desired features.

Alternatively, a patent owner might be interested in running periodic searches to identify products that are potentially infringing their products.

As a further alternative, a user who is drafting a patent application might benefit from knowledge gained by identifying existing products that include one or more features being described in the patent application. Descriptions of these products could then be used, for example, to enhance the disclosure in the patent application, identifying potential infringers, and/or help determine whether it is worthwhile to prepare and file the application.

According to one or more embodiment, the present disclosure provides a database including targeted advertisements based on the contents of a document identified in response to a search query or document request submitted to an invention disclosure database. According to an exemplary embodiment, an invention disclosure database may include a variety of invention-related documents including invention submissions, patent applications, issued patents and the like. Accordingly, for the purpose of the present disclosure, an “invention disclosure document” includes all invention-related documents including invention submissions, patent applications, issued patents, defensive invention publications, and the like.

According to a first example, when the system displays a document such as a patent or patent application, the system can display the document and one or more advertisements. The particular advertisement(s) displayed with the document may be selected from a multiplicity of available advertisements based on words in the document. For an example of suitable systems and methods for generating advertising based on the content of a displayed document, see published U.S. patent application entitled “Methods and apparatus for serving relevant advertisements”, publication No. 2004/0059708 A1 to Dean et al, published on Mar. 25, 2004, which is incorporated by reference herein.

The document may be displayed in response to a database query or document request to a public, private, or proprietary database. For example, the document may be displayed in response to a query of the U.S. Patent and Trademark Office patent database at www.uspto.gov. The query may result in the display, in whole or in part and/or a link to or of a single document, multiple documents, or a results list associated with one or more documents. According to some embodiments, the end user may need to select a particular document or link in a results list (for example, the user may need to click on a hyperlink) in order to view a given document and the associated targeted advertising.

The query may include one or more keywords which are used to generate the search results. Alternatively, the user may simply provide one or more of a patent application number, patent number, title, inventor name, assignee name, or other identifying information in order to obtain the invention disclosure document(s) of interest. In certain embodiments, new or existing search engines may be employed to perform part or all of the steps necessary to retrieve one or more documents.

The available advertisements may be stored in one or more databases, for example, in a public, private, or proprietary advertisement database. The database may further include information related to financial transactions, advertisement owner, and any other information, e.g., relevancy scores, synonyms and antonyms, etc.

In another embodiment, an end user enters the text of a draft patent application and/or other information directly into a web-based or other system. Based on the content of the submitted disclosure or patent application, advertisements may be displayed to the end user. For example, a patent application may be submitted to the system using an automated web-based application preparation and submission system or tool. An exemplary web-based patent application drafting system is described in U.S. patent application Ser. No. 11/627,263, “Automated Web Based Application Preparation and Submission,” filed Jan. 25, 2007, which is hereby incorporated by reference.

Furthermore, when an invention is entered into the system, the system may allow service providers to offer their services based on the words of the invention description. An advertisement or real time chat window could be opened up in the browser session and the end user upsold the opportunity to use the services provided by the service providers.

According to yet another embodiment rather than passive advertisement in which an advertiser relies on a request or query from an end user, an advertiser could purchase the right to convert a word in an invention disclosure document such as a defensive invention publication, patent application publication, or issued patent into a hyperlink that, when clicked or otherwise activated, outputs an advertisement. For example, by using the methods and system described above.

Those having skill in the art will recognize that there is little distinction between hardware and software implementations. The use of hardware or software is generally a choice of convenience or design based on the relative importance of speed, accuracy, flexibility and predictability. There are therefore various vehicles by which processes and/or systems described herein can be effected (e.g., hardware, software, and/or firmware) and that the preferred vehicle will vary with the context in which the technologies are deployed.

At least a portion of the devices and/or processes described herein can be integrated into a data processing system with a reasonable amount of experimentation. Those having skill in the art will recognize that a typical data processing system generally includes one or more of a system unit housing, a video display device, memory, processors, operating systems, drivers, graphical user interfaces, and application programs, interaction devices such as a touch pad or screen, and/or control systems including feedback loops and control motors. A typical data processing system may be implemented utilizing any suitable commercially available components to create the gaming environment described herein.

Accordingly, the presently described system may comprise a plurality of various hardware and/or software components. An exemplary system 20 is shown in FIG. 5 and described below. However, it will be understood that a nearly unlimited number of variations are possible and that such description is intended to provide a non-limiting example of an implementation that could be utilized but should not be used to define the entire scope of the invention.

Accordingly, a system 20 configured to perform the various functions described above may incorporate a number of software modules configured to perform various tasks. Exemplary software modules useful for the presently-described system include:
a. Ad Generation Program 22
b. Ad Presentation Program 24
c. Billing Program 26

System 20 may further comprise a plurality of databases configured to store and associate a variety of data. Non-limiting examples of databases useful for the presently-described system include:

End User Database 28
11. End User ID
12. End User Profile
13. End User Billing Info

Advertiser Database 30
1. Advertiser ID
2. Advertiser Profile
3. Advertiser Billing Info

Advertisement Database 32
1. Advertisement ID
2. Advertiser ID
3. Advertisement Content
4. Advertisement Keyword
5. Advertisement Class 1-N
6. Advertisement Subclass 1-N
7. Patent Number 1-N
8. Advertisement Fee Range

Accordingly, a system such as that described herein will be configured to perform various functions, such as those described above, by performing various method steps in order to accomplish one or more given tasks. Non-limiting examples of methods that may be performed by a system and the steps that the system may execute in order to perform these methods are described below:

Create Ad
1. Receive word, patent class, and patent subclass
2. Receive advertisement description and maximum fee.
3. Generate and output list of patent applications where that contain the word in the patent class and subclass and/or patent number(s)
4. Receive approval of some or all patent applications in list
5. Create hyperlinks of words that link to advertisement description

View Ad
1. Receive click on hyperlink of word in a patent application
2. Retrieve Advertisement Description
3. Output Advertisement Description

Bill Advertiser for Viewed Ad
1. Output Advertisement Description
2. Determine Fee
3. Apply Fee to Advertiser Account

In a further embodiment, service providers and/or advertisers could be certified, for example, by the system provider or by a third party.

The system may be configured to facilitate communications between the end user and the advertisers/service providers, for example, end users could elect to receive solicitations from one or more service providers associated with the system. In addition or in the alternate, end users may choose to engage in a chat session or other real time or delayed communications with a representative from any such merchant, advertiser and/or service providers and vice versa, including, for example, use of alerts, email, instant text messaging and other forms of communications each of which are well known by those of ordinary skill in the art.

According to a further embodiment, the system could build up a profile for each user that helps the system better understand the type of patent applications and/or products and/or features or ideas in which the user has an interest. For example, by identifying information about applications for which the user has previously filed, searched, etc., such information would identify to the system, for example, that a particular end user files a lot of process patents and very few devices patents, and files applications that are mostly software related, etc. This information could aid online tools, and/or merchants and/or search engines, such as those described in greater detail below, to place a higher priority on the most applicable information, such as prior art, suggestions, etc. The profile could also be used to help determine which advertising would yield the most desirable results, given the user's current activity.

The system may further provide a system and method for generating revenue based on advertising displayed in conjunction with the display of an invention disclosure document. For example, the system may be configured to identifying when and if an end user responds to an advertisement, for example by clicking on an advertisement or purchasing an item from the advertiser and/or by responding to a survey. The system may further be configured to charge a fee to the advertiser each time an end user response to an advertisement. Alternatively or additionally, the system may be configured to facilitate transactions between the advertisers and the end users. For example, advertisers could provide a benefit to the end user to review the ads, take surveys, provide product reviews, etc. Exemplary benefits may be cash payments, discounts, coupons, special offers, etc.

According to yet another embodiment, the system may be configured to permit advertisers to “bid” on ad space for a particular end user, based upon the type of invention disclosure information requested, relevancy of the advertiser's products, end user's budget, pre-existing relationships, advertiser's resource availability, etc.

The system can be built utilizing three different architectural methods: 1) a simple, table based method 2) a rules based system or 3) an artificial intelligence (AI) system such as Neural Net, or Bayesian Algorithm.

Those having skill in the art will recognize that there is little distinction between hardware and software implementations. The use of hardware or software is generally a choice of convenience or design based on the relative importance of speed, accuracy, flexibility and predictability. There are therefore various vehicles by which processes and/or systems described herein can be effected (e.g., hardware, software, and/or firmware) and that the preferred vehicle will vary with the context in which the technologies are deployed.

At least a portion of the devices and/or processes described herein can be integrated into a data processing system with a reasonable amount of experimentation. Those having skill in the art will recognize that a typical data processing system generally includes one or more of a system unit housing, a video display device, memory, processors, operating systems, drivers, graphical user interfaces, and application programs, interaction devices such as a touch pad or screen, and/or control systems including feedback loops and control motors. A typical data processing system may be implemented utilizing any suitable commercially available components to create the gaming environment described herein.

Accordingly, the presently described system may comprise a plurality of various hardware and/or software components. An exemplary system 10 is shown in FIG. 6 and described below. However, it will be understood that a nearly unlimited number of variations are possible and that such description is intended to provide a non-limiting example of an implementation that could be utilized but should not be used to define the entire scope of the invention.

Accordingly, a system 10 configured to perform the various functions described above may incorporate a number of software modules configured to perform various tasks. Exemplary software modules useful for the presently-described system include:

Profile Generation Program 12—this program generates a profile for advertisements, end users, and patent applications so that they can be related to one another.

Advertisement Generation Program 14—this program generates advertisements that are displayed to end users in the web-based application. The advertisements displayed are based on the relevance of an advertisement profile to an end user or a patent application of an end user.

System 10 may further comprise a plurality of databases configured to store and associate a variety of data. Non-limiting examples of databases useful for the presently-described system include:

End User Database 16, which may store and associate data such as:
1. End User ID
2. End User Contact Info
3. End User Profile ID
4. End User Billing Info
5. Patent Application Database
6. Patent Application ID
7. End User ID
8. Patent Application Profile ID

Advertiser Database 18, which may store and associate data such as:
1. Advertiser ID
2. Advertiser Billing Info
3. Advertisement Database
4. Advertisement ID
5. Advertiser ID
6. Advertisement Content
7. Advertisement Profile

Accordingly, a system such as that described herein will be configured to perform various functions, such as those described above, by performing various method steps in order to accomplish one or more given tasks. Non-limiting examples of methods that may be performed by a system and the steps that the system may execute in order to perform these methods are described below:

Generate advertisement based on patent application
1. Receive Patent Application Information
2. Determine relevant advertisements based on patent application information
3. Output Relevant Advertisements
4. Receive indication of interest for a relevant advertisement
5. Determine value of indication of interest
6. Bill the advertiser account the value amount for the indication of interest

Generate advertisement based on end user profile
1. Receive End User Log on
2. Retrieve end user profile
3. Determine relevant advertisements based on end user profile
4. Output Relevant Advertisements
5. Receive indication of interest for a relevant advertisement
6. Determine value of indication of interest
7. Bill the advertiser account the value amount for the indication of interest

It should be understood that, the systems and methods of the present disclosure may be practiced in the real or virtual world or both. For example, a video game may include a repository or database of documents, for example, a virtual patent office or a collection of conversations typed or spoken in the virtual world. Methods and systems for providing a virtual patent office and registration of virtual intellectual property are disclosed, for example, in U.S. patent application Ser. No. 11/679,669 which is incorporated herein by reference. Accordingly, the disclosed invention may similarly be applied to a virtual environment, world or video game(s) or any combination of the foregoing. For example, advertisements, such as those disclosed herein, may be delivered in the virtual world. In such cases, methods to ensure that agreements are enforceable and that advertising fees are collected in such virtual environments are desirable. Methods for providing such contract enforcement and collection of fees are disclosed, for example, in U.S. patent application Ser. Nos. 11/279,991, 11/624,662, 11/559,158, 11620,542, 11/421,025, and 11/380,489 which are hereby incorporated herein by reference. Accordingly, it will be appreciated that all embodiments herein which refer to a system for real world documents such as patents can also apply to a system that manages virtual patent applications that are filed by players in a virtual environment such as, for example, Linden Lab's Second Life.

Of course it will be appreciated that the systems methods described herein are provided for the purposes of example only and that none of the above systems methods should be interpreted as necessarily requiring any of the disclosed components or steps nor should they be interpreted as necessarily excluding any additional components or steps. Furthermore, it will be understood that while various embodiments are described, such embodiments should not be interpreted as being exclusive of the inclusion of other embodiments or parts of other embodiments.

The invention is described with reference to several embodiments. However, the invention is not limited to the embodiments disclosed, and those of ordinary skill in the art will recognize that the invention is readily applicable to many other diverse embodiments and applications as are reflected in the range of real world financial institutions, instruments and activities. Accordingly, the subject matter of the present disclosure includes all novel and nonobvious combinations and subcombinations of the various systems, methods configurations, embodiments, features, functions, and/or properties disclosed herein.

A reference to “another embodiment” in describing an embodiment does not necessarily imply that the referenced embodiment is mutually exclusive with another embodiment (e.g., an embodiment described before the referenced embodiment), unless expressly specified otherwise.

The terms “include”, “includes”, “including”, “comprising” and variations thereof mean “including but not limited to”, unless expressly specified otherwise.

The term “consisting of” and variations thereof includes “including and limited to”, unless expressly specified otherwise. The terms “a”, “an” and “the” mean “one or more”, unless expressly specified otherwise.

The term “plurality” means “two or more”, unless expressly specified otherwise.

The term “herein” means “in this patent application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

The term “represent” and like terms are not exclusive, unless expressly specified otherwise. For example, the term “represents” does not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The terms “such as”, “e.g.” and like terms means “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like. It does not imply certainty or absolute precision, and does not imply that mathematical processing, numerical methods or an algorithm process be used. Therefore “determining” can include estimating, predicting, guessing and the like.

It will be readily apparent to one of ordinary skill in the art that the various processes described herein may be implemented by, e.g., appropriately programmed general purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions.

A “processor” may include one or more microprocessors, central processing units (CPUs), computing devices, microcontrollers, digital signal processors, or like devices or any combination thereof. Thus a description of a process is likewise a description of an apparatus for performing the process. The apparatus can include, e.g., a processor and those input devices and output devices that are appropriate to perform the method. Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” includes any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and /or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer /computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) are well known and could be used to store and manipulate the data types described herein. Likewise, object methods or behaviors of a database can be used to implement various processes, such as the described herein. In addition, the databases may, in a known manner, be stored locally or remotely from any device(s) which access data in the database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, or a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Those having skill in the art will recognize that there is little distinction between hardware and software implementations. The use of hardware or software is generally a choice of convenience or design based on the relative importance of speed, accuracy, flexibility and predictability. There are therefore various vehicles by which processes and/or systems described herein can be effected (e.g., hardware, software, and/or firmware) and that the preferred vehicle will vary with the context in which the technologies are deployed.

At least a portion of the devices and/or processes described herein can be integrated into a data processing system with a reasonable amount of experimentation. Those having skill in the art will recognize that a typical data processing system generally includes one or more of a system unit housing, a video display device, memory, processors, operating systems, drivers, graphical user interfaces, and application programs, interaction devices such as a touch pad or screen, and/or control systems including feedback loops and control motors. A typical data processing system may be implemented utilizing any suitable commercially available components to create the environment described herein.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each claim in a set of claims has a different scope. Therefore, for example, where a limitation is explicitly recited in a dependent claim, but not explicitly recited in any claim from which the dependent claim depends (directly or indirectly), that limitation is not to be read into any claim from which the dependent claim depends.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device /article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention which must be present in all embodiments.

Neither the Title (set forth at the beginning of the first page of this patent application) nor the Abstract (set forth at the end of this patent application) is to be taken as limiting in any way as the scope of the disclosed invention(s). An Abstract has been included in this application merely because an Abstract of not more than 150 words is required under 37 C.F.R. § 1.72(b).

The title of this patent application and headings of sections provided in this patent application are for convenience only, and are not to be taken as limiting the disclosure in any way.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described in a sequential order, such processes may be configured to work in different orders. In other words, any sequence or order of steps that may be explicitly described does not necessarily indicate a requirement that the steps be performed in that order. On the contrary, the steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not imply that all or any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

Unless expressly specified otherwise, an enumerated list of items (which may or may not be numbered) does not imply that any or all of the items are mutually exclusive. Therefore it is possible, but not necessarily true, that something can be considered to be, or fit the definition of, two or more of the items in an enumerated list. Also, an item in the enumerated list can be a subset (a specific type of) of another item in the enumerated list. For example, the enumerated list “a computer, a laptop, a PDA” does not imply that any or all of the three items of that list are mutually exclusive—e.g., an item can be both a laptop and a computer, and a “laptop” can be a subset of (a specific type of) a “computer”.

Likewise, unless expressly specified otherwise, an enumerated list of items (which may or may not be numbered) does not imply that any or all of the items are collectively exhaustive or otherwise comprehensive of any category. For example, the enumerated list “a computer, a laptop, a PDA” does not imply that any or all of the three items of that list are comprehensive of any category.

Further, an enumerated listing of items does not imply that the items are ordered in any manner according to the order in which they are enumerated.

In a claim, a limitation of the claim which includes the phrase “means for” or the phrase “step for” means that 35 U.S.C. § 112, paragraph 6, applies to that limitation.

In a claim, a limitation of the claim which does not include the phrase “means for” or the phrase “step for” means that 35 U.S.C. § 112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. § 112, paragraph 6, applies to that step(s).

With respect to a means or a step for performing a specified function in accordance with 35 U.S.C. § 112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in this patent application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. § 112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

The present disclosure provides, to one of ordinary skill in the art, an enabling description of several embodiments and/or inventions. Some of these embodiments and/or inventions may not be claimed in this patent application, but may nevertheless be claimed in one or more continuing applications that claim the benefit of priority of this patent application. Applicants intend to file additional applications to pursue patents for subject matter that has been disclosed and enabled but not claimed in this patent application.

What is claimed is:

1. A method comprising:
providing a plurality of patent disclosure documents,
categorizing keywords that appear in the document;
receiving a request from an entity to hyperlink a first keyword to a destination document;
hyperlinking at least one instance of the keyword in the document to the destination document; and
receiving compensation from the entity for hyperlinking the keyword.

2. The method of claim 1 further comprising suggesting alternate keywords to the entity for hyperlinking.

3. The method of claim 2 wherein the alternate keywords are synonyms of the first keyword.

4. The method of claim 3 further comprising:
determining that a second entity has requested that a second and third keyword be linked to the same destination document;
identifying the keywords as being associated with each other.

5. The method of claim 4 further comprising:
determining that the first keyword is identical to the second keyword; and
suggesting the third keyword as an alternate keyword.

6. The method of claim 1 wherein categorizing keywords comprises determining the USPTO classification number of the patent disclosure and associating the keyword with the USPTO classification number.

7. The method of claim 6 wherein receiving a request from an entity to hyperlink a first keyword comprises receiving a request to hyperlink the keyword if it has been associated with a given USPTO classification number.

8. The method of claim 1 wherein the destination document is an advertisement.

9. The method of claim 8 wherein the advertisement is a website operated by the entity.

10. The method of claim 1 further comprising tracking the number of times the hyperlinked keyword is selected by a user.

11. The method of claim 10 wherein the amount of compensation received is determined by the number of users who select the keyword.

12. A system comprising:
a database comprising a plurality of patent disclosure documents, wherein at least one patent disclosure document includes at least one keyword that is hyperlinked to an advertisement owned by an entity;
an advertising module configured to:
receive a keyword selection from the entity;
receive an advertisement from the entity; and
hyperlink the advertisement to at least one instance of the keyword; and
a fee module configured to:
receive compensation from the entity; and
track the frequency with which the hyperlink is activated.

13. The system of claim 12 further comprising a lexicon module configured to categorize keywords that appear in the patent disclosure documents.

14. The system of claim 13 wherein the lexicon module is configured to:
identify related words; and
suggest to the entity a word that has been identified as being related to the keyword selected by the entity.

15. The system of claim 12 wherein the compensation received is based on the frequency with which the hyperlink is activated.

16. The system of claim 12 wherein each keyword in the database is identified with a patent classification number.

17. The system of claim 16 wherein the keyword selection from the entity comprises an indication of a patent classification number.

18. A method comprising:
accessing a database of patent disclosure documents;
selecting a keyword that appears in at least one of the documents in the database;
receiving a list of suggested alternate keywords;
requesting that an advertisement be associated with the keyword; and
paying a fee to have the advertisement associated with the keyword.

19. The method of claim 18 further comprising:
selecting at least one of the suggested alternate keywords; and
requesting that the advertisement be associated with the selected suggested alternate keyword.

20. The method of claim 18 further comprising receiving an indication of the number of times the advertisement was viewed by a user accessing the database.
